(19) United States
(12) Patent Application Publication
(10) Pub. No.: US 2007/0099240 A1
(43) Pub. Date: May 3, 2007

(54) Pixel arrays

(76) Inventors: Wouter Cornelis Puijk, Lelystad (NL); Evert van Dijk, Giethoorn (NL); Jelle Wouter Slootstra, Lelystad (NL)

Correspondence Address: TRASK BRITT, P.O. BOX 2550, SALT LAKE CITY, UT, 84110, US

(21) Appl. No.: 11/595,775

(22) Filed: Nov. 10, 2006

Related U.S. Application Data
(63) Continuation of application No. 10/642,553, filed on Aug. 14, 2003.
Application No. 10/642,553 is a continuation of application No. PCT/NL02/00097, filed on Feb. 15, 2002.

(30) Foreign Application Priority Data
Feb. 16, 2001 (EP) 01200551.8

(51) Int. Cl. C40B 30/06; C40B 60/04

(52) U.S. Cl. 435/7.1

(57) ABSTRACT

The invention relates to the detection of biomolecules or analogs of the biomolecules in micro-arrays and the supports used for the micro-arrays. Methods for determining or testing binding of a first member molecule within an array or library of tentative first member binding molecules for binding with a second member binding molecule are disclosed. A support for a micro-array suitable for determining binding of a first member molecule within a library of spots of tentative first member binding molecules with a second member binding molecule is disclosed. The support includes a support surface wherein surface patches are interspersed within surface areas that are materially distinct from the patches.

### CROSS-REFERENCE TO RELATED APPLICATIONS

This application is a continuation of application Ser. No. 10/642,553, filed Aug. 14, 2003, pending, which is a continuation of PCT/NL02/00097, filed Feb. 15, 2002, designating the United States of America, corresponding to PCT International Publication WO 02/066984 (published in English on Aug. 29, 2002), the contents of each of which are incorporated herein in their entirety.

### STATEMENT ACCORDING TO 37 C.F.R. § 1.52(e)(5)—SEQUENCE LISTING SUBMITTED ON COMPACT DISC

Pursuant to 37 C.F.R. § 1.52(e)(1)(iii), a compact disc containing an electronic version of the Sequence Listing has been submitted concomitant with this application, the contents of which are hereby incorporated by reference. A second compact disc is submitted and is an identical copy of the first compact disc. The discs are labeled “copy 1” and “copy 2,” respectively, and each disc contains one file entitled “2183-6064.1US SEQ LIST.txt” which is 82 KB and created on Aug. 14, 2003.

### BACKGROUND OF THE INVENTION

1. Field of the Invention

The invention relates to the detection of (bio)molecules, or analogues thereof, in micro-arrays and the supports used for the micro-arrays. More particularly, the invention relates to methods for determining or testing binding of a first member molecule within an array or a library of tentative first member binding molecules with a second member binding molecule, wherein the first and second molecules are each members of a binding pair. The invention further relates to enzyme-linked detection of the binding pair in high-density micro-array systems.

2. State of the Art

Interactions, or the formation of a specific binding pair, between binding molecules, which in general are bio-molecules, and their corresponding ligands, which in general are also bio-molecules, are central to life. Cells often bear or contain receptor molecules that interact or bind with a hormone, a peptide, a drug, an antigen, an effector molecule or with another receptor molecule. Examples of binding pairs include: enzymes that bind with their respective substrate; antibody molecules that bind with an antigen; nucleic acids that bind with a protein, and so on. The terms “interact” or “bind” as used herein are meant to refer to the range of molecular forces between the binding molecule and ligand (or the functional parts thereof) as they approach each other, and may influence each other's properties. This approach takes the binding molecule and its ligand through various stages of molecular recognition comprising increasing degrees of intimacy and mutual effect, thus the two members bind and form a pair.

Binding molecules have this binding ability because the binding molecules have distinct binding sites that allow for the recognition of the ligand in question. The ligand, in turn, has a corresponding binding site, and when the two binding sites interact—essentially spatial—complementarity, the two molecules can bind. Molecules typically have three dimensions and binding sites are often of a three dimensional nature, wherein one molecule includes one or more surface projections or protuberances as one binding site that corresponds to one or more pockets or depressions on the other binding molecule, such as a three-dimensional lock-and-key arrangement that may be an induced-fit variety.

Due to the central role binding molecules and their ligands play in life, there is an ever expanding interest in testing for or identifying the nature or characteristics of the binding site and the members of the binding pair of molecules involved in such a site. Not only is one interested in the exact nature of the particular interaction between the binding molecule and ligand in question, e.g., in order to replace or supplement binding molecules or ligands when needed, one is also interested in knowing the approximating characteristics of the interaction in order to find, or design, analogs, agonists, antagonists or other compounds that mimic a binding site or ligand involved.

Versatile and rapid methods to test for or identify binding pairs and its separate members exist. For instance, most, if not all nucleic acid detection techniques, and molecular libraries using these detection techniques entail hybridization of an essentially continuous nucleic acid stretch with a complementary nucleic acid strand, such as DNA, RNA or PNA. Proteins and peptides are often detected using antibodies, or derivatives or synthetic variants thereof. Arrays of biological molecules, i.e., micro-arrays, are used in standard techniques in many laboratories. Such micro-array-based detection generally includes a method in which a member of a specific binding pair is detected by means of an optically detectable reaction. Different supports for the libraries including tentative or possible first members of the binding pair (such as nucleic acid, peptide, or of any other nature) are used, but can be divided into two types: porous surfaces and non-porous surfaces.

Porous surfaces, such as membranes, cellulose and paper, are probably the oldest support in use. For example, “dot blots” are widely used today. The synthesis of macromolecules, e.g., nucleic acids or peptides, has been described on these porous matrices. Paper was used as a relatively thick, continuous porous matrix on which first member constructs were synthesized spot wise. Binding pairs were generally identified by detection with, directly or via indirectly, enzyme labeled probes, thus, allowing increased sensitivity over the use of probes that were directly labeled with an optically detectable reporter molecule, such as a fluorescent group. A disadvantage of these methods is that the density of spots in these matrices is limited. This limitation is caused, inter alia, by the diffusion of the enzymatically changed substrate in the matrix. To avoid the diffusion and, thus, the inaccurate localization of a binding pair in the field of peptide synthesis, methods using polyethylene pins (Geysen, 1983) or in polypropylene wells (Slootstra, 1995; 1997) exist. However, these “early” methods have the disadvantage that no high density arrays (approximately up to not more than 10-20 spots/cm2) can be facilitated for various reasons.

The existence of limited spot densities in the arrays is the reason why more nonporous surfaces are becoming more widely used. In the field of genomics, huge arrays of polynucleotide sequences are spotted on a variety of surfaces, typically glass slides covered with different coatings (See, U.S. Pat. Nos. 6,015,880 and 5,700,637). Array densities of 1000 spots/cm2 are possible. Even higher densities are possible when the biomolecules (i.e., polynucleotide sequences) are synthesized in-situ (See, U.S. Pat. No. 5,871,928). For example, in a traditional gene expression assay designed to profile the expression of many genes in parallel, mRNA is prepared from two different tissue types, e.g., normal and diseased samples. The isolated mRNA represents a snapshot of the current state of expression within the cells. The mRNA is converted to DNA via a first strand cDNA labeling reaction. After target DNA is deposited onto coated glass slides and directly labeled cDNA probes are hybridized to the arrays, the hybridized arrays are imaged using an array scanner and the results are examined for differences in expression levels using several image and data analysis software tools. A more intricate porous support surface has been described for these purposes (See, PCT International Publication WO 00/56934) that uses continuous porous matrix arrays. On microscope slides, a continuous slab of polyacrylamide is formned, e.g., 20 um thick and having a thin, continuous porous matrix (hydrogel) that is combined with a non porous surface (glass).

Detection of specific binding pairs on or in the high-density supports is achieved with directly labeled probes that include optically detectable, e.g., fluorescent, nucleotides or antibodies. The detection techniques are highly sensitive, have low non-specific binding and high photo stability. Labeled nucleotides are widely used for labeling DNA and RNA probes, especially for multicolor analysis in micro-arrays, but also for FISH, chromosome identification, whole chromosome painting, karyotyping and gene mapping.

Labeled nucleotides are available in a range of bright, intense colors having narrow emission bands that are ideal for multiplexing within a single sample. For protein or peptide detection, fewer fluorescently labeled probes are available since the field of protein or peptide based high-density micro-array systems is not as well developed as micro-arrays based on nucleic acid detection.

### SUMMARY OF THE INVENTION

In one exemplary embodiment, an array or library of first members is disclosed, in general spatially and/or addressable bound, most often covalently, to such a support, e.g., by spotting or gridding. A second member, the detecting or specific binding molecule, which is directly or indirectly labeled with a marker molecule (such as a fluorescent compound) to facilitate optical detection of the aforementioned pair is also disclosed to detect the putative first members of the array with which it can bind. The second member can of course be a nucleic acid, a receptor molecule, an antibody or the like. Binding of the second member, thus, identifies the first member because of its specific localization on the support.

The invention combines the advantages of high density arraying, i.e., testing a lot of binding events at once, and enzyme-linked assays (very sensitive), thus, allowing for the detection of more binding pairs more rapidly. Micro-array systems are disclosed herein that work with enzyme-linked assays in order to detect the molecule of interest on a high-density support. Such testing of high densities of constructs on a solid support in a enzyme-linked assay is disclosed by the invention, wherein a first member is attached to or synthesized on one side of a surface of the support in a density of at least 25, at least 50, at least 100, about 200-500, or even 1000 spots per square centimeter.

In one exemplary embodiment, the invention describes a support of polymeric material, i.e., a polymeric support, having a library of spots of the tentative first member binding molecules in a density of at least 25 spots, at least 50 spots, at least 100 spots, about 200-500 spots, or even 1000 spots per square centimeter. In another exemplary embodiment, the polymeric material comprises polypropylene having hydrophilic patches.

The first binding pair members may be spotted or gridded in a positionally or spatially addressable way such that many different constructs or first member molecules on the support can interact with a second member or binding molecule. The spots can overlap, as long as the constituting collection of first member molecules are spatially addressable and distinct. Spotting can be done using piezo drop-on-demand technology or by using miniature solenoid valves. Gridding can be done using a set of individual needles that pick up sub-microliter amounts of segment solution from a microtiter plate, wherein the segment solution includes solutions having the first members.

When peptides are tested, the support may be de-protected and extensively washed after the linking reaction to remove uncoupled peptides. The disclosed method gives a peptide construct density as large as 25 to 50, even 100 to 200, or up to 500 to 1000 spots per square centimeter. This density allows for the screening of a large number of possible peptide constructs of the proteins that bind with an antibody. For example, in one exemplary embodiment, 25,000 to 100,000 constructs are made on a 1000 square centimeter surface. The surface is screened for binding in an enzyme-linked assay, be it directly or indirectly, wherein a fluorescent substrate is generated with 100 ml of enzyme-labeled probe solution that contains 1-10 μg of probe/ml. The screened surface is developed with an optically detectable substrate using established techniques.

The invention, thus, discloses a method for determining the binding of a first member molecule from a library of tentative first member binding molecules with a second member binding molecule. The method comprises providing a polymeric (such as the polypropylene type surface having hydrophilic patches) or plastic support with a library of spots of the tentative first member binding molecules in a density of at least 25 spots per square centimeter. The method further comprises detecting the binding of the first member molecule with the second member molecule with an enzyme-linked assay, wherein the enzyme-linked-assay comprises the production of a fluorescent or chemiluminescent substrate. Fluorescent substrates can be produced with a host of enzyme systems, such as horse-radish-peroxidase, alkaline phosphatase or other known substrate-enzyme systems such as those disclosed in Mendoza et al. including “High-throughput microarray-based enzyme-linked immunosorbent assay (ELISA),” Biotechniques, Eaton Publishing, Natick, US vol. 27, (1999), where an optically flat, glass-based support is described, including multitudes of identically patterned arrays of antigens printed to the glass.

As described herein, indirect or direct fluorescence detection allocates antibody binding constructs. For instance, direct fluorescence detection with confocal scanning detection methods allows antibody detection on spots generated with droplets having peptide-solution in the sub-nanoliter range, which makes even higher construct densities feasible. Nucleic acid libraries may be made in a similar fashion using enzyme-labeled nucleic acid probes.

Furthermore, the invention describes a support for a micro-array configured for testing binding of a first member molecule within an array or library of tentative first member binding molecules with a second member binding molecule. The support includes a surface having patches that are interspersed within areas, wherein the areas are materially distinct from the patches. In general, the surface is obtained using various complicated methods that comprise masking and subsequent photographic exposure and development (See, PCT International Publication WO 94/27719), plasma treatment, polymerization, photo-oxidation or electron beam treatment (See, WO 99/58245). Other techniques (See, Canadian Publication CA 2260807) require an inert solid support material to which the hydrophobic and hydrophilic areas need be applied, such as by way of coating. Other techniques (See, Great Britain Publication GB 2332273) provide an extremely hydrophobic surface in relation to the sample solution that is applied after which samples are thought to adhere to the surface by drying. In U.S. Pat. No. 5,369,102, a support with two opposing surfaces, one hydrophobic and the opposing one hydrophilic, are provided for the attachment of cells to the hydrophilic surface. PCT International Publication WO 99/32705 discloses various grafting protocols, but does not disclose requirements as to roughness of the surface, or to a pattern of hydrophilic and hydrophobic patches.

The present invention has recognized that masking or coating is not required and that grafting surfaces, such as polypropylene, is suitable provided that at least one side of the surface of the starting material, such as a substantially flat surface of at least 0.5 square centimeters or at least 1 square centimeter, is configured with a substantial roughness characterized by elevations and depressions. The rough surface allows for the interspersed character of hydrophobic and hydrophilic patches to occur on the side or surface. The pattern of hydrophilic (hydrophilic matrices typically cause severe diffusion) and hydrophobic areas (which may block diffusion) as disclosed herein diminish diffusion, especially when the patches are smaller than the droplet size of dispensed material (spots), which are the smallest when the spot density is the highest.

In one exemplary embodiment, the invention discloses a support, wherein the surface of the areas essentially comprises relatively hydrophobic polypropylene and the surface of the patches essentially comprise polypropylene having a relatively hydrophilic material, such a grafted polyacrylic acid. The support disclosed herein comprises at least a spot or dot, e.g. a collection of first member molecules such as a nucleic acid or peptide construct, density as large as 25, or up to 50, 100, 200, 500 or even 1,000 spots per square centimeter. Further, the spots or dots are positionally or spatially addressable, wherein each of the spot or dot covers at least one patch, but the spot or dot may cover from 3-5, or even from 5-15 or more hydrophilic patches or pixels.

Although the surface, such as the polypropylene, may not be completely covered with a homogenous graft, the high loadings of peptide or nucleotide per square centimeter are possible due to the relatively high surface occupation of the grafts, such as polyacrylic acid, on the surface. Thicker grafts can carry higher peptide or nucleic acid loadings, but may suffer from more diffusion problems of dispensed material because of the growing occupation of grafted surface. Thus, the material can be made to suit various needs as regard to loading versus diffusion.

The invention further discloses a solid support having at least one peptide, or at least one nucleotide. The solid support may include a plurality of peptides (or likewise of nucleotides), wherein the peptides or nucleotides are arranged in spots.

In another exemplary embodiment, the invention describes a method for determining binding of a first member molecule within a library of tentative first member binding molecules with a second member binding molecule. The method includes providing at least one surface of a support having a library of spots of the tentative first member binding molecules, detecting the binding in an enzyme-linked assay and providing for limited, minimalized or restricted diffusion of an optically detectable marker molecule. Since diffusion is limited, the enzymatic reaction and the deposit or localization of the resulting (optically) detectable marker molecules can be determined with more precision and allow for higher densities than with previous micro-arrays using enzyme-linked-detection.

In a further exemplary embodiment, the invention discloses a method where the diffusion is limited by providing at least one surface of the support having surface patches that are interspersed within surface areas, wherein the surface areas are materially distinct from the patches. (See, FIG. 1). The invention also provides a support (also referred to as a discontinuous matrix array or pixel array), wherein the support surface material is of a varied or discontinuous nature as regards to hydrophilicity. In one embodiment of a support having a high-density micro-array, patches of relative hydrophilicity are interspersed with areas of relative hydrophobicity. There does not need to be a sharp border between the patches and the surrounding area. It is sufficient when distinct material differences or discontinuities exist between the center of a patch and the middle line of a surrounding area, wherein there is a more or less gradual material change in between.

The patches and surrounding areas may be in a strict matrix or grid format, but this is not necessary. The patches are at least one or two dimensions smaller than the size of the circumference of the positioned droplets or spots of first member molecules that, in a later phase, will be provided to the support surface. Since the patches are smaller than the droplets or spots, at least 3-5 or at least 10-20 hydrophilic patches will fit within the circumference of a later spotted spot or droplet of the solution of a first member, whether the first member is a nucleic acid, a peptide, any other (bio-)molecule or combination thereof. The patches resemble pixels that, after a marker molecule has attached to a specific binding pair, create the optically detectable image, wherein a spot with a collection of first member molecules bound to second member molecules is detected.

In another exemplary embodiment, a one-to-one fit of pixel or patch to droplet or spot is also feasible even when the patch is larger than a spot, but this not necessary. It is also not necessary to apply or provide the patches in a regular pattern. When a droplet or spot is provided, the interspersed hydrophobic character of the support surface will limit the diffusion of any aqueous solution. The diffusion of a solution of an optically detectable substrate (be it as precipitate or as solution) formed after the enzymatic reaction has taken place will also be limited in a later phase. The enzymatic reaction takes place when a first member is bound to a second member of a binding pair, wherein the presence of the relatively hydrophilic patch or patches within the droplet or spot circumference allows the substrate to be positioned, or detectable. The patches disclosed herein may also be described as pixels within the spot(s), wherein the optically detectable or fluorescent substrate will finally be located. If so desired, patches may be hydrophobic where the surrounding area is relatively hydrophilic, when, for example, solutions or (optically detectable) markers are tested of a more hydrophobic nature.

In another exemplary embodiment, the support described herein comprises at least a spot or dot, e.g., a collection of first member molecules such as a nucleic acid or peptide construct, density as large as 25 or 50, even 100, 200, up to 500, or even 1,000 spots per square centimeter. The spots or dots are positionally or spatially addressable, wherein each of the spots or dots cover at least one patch, cover from 3-5 patches, or even 5-15 or more patches or pixels.

Hydrophilic path sizes can be modified by selecting the appropriate support material, such as polyethylene, polypropylene or another relatively hydrophobic plastic material to begin with, or by providing the patch size with patches in the desired size, such as by utilizing print technology. For instance, a support surface may be produced from a relatively hydrophobic polypropylene surface upon which grafts are provided that form the relatively hydrophilic patches. The grafts are made with polyacrylic acid that has an excellent suitable hydrophilic nature and allows for testing under physiological circumstances. The patch size may be influenced by selecting the appropriate roughness or a polyethylene or polypropylene starting material. The roughness can also be modulated by sanding, polishing, any other mechanical (printing) or chemical (etching) method, or combinations thereof to modulate a surface on which the hydrophilic patches are to be generated. The smaller the hydrophilic patch size, the smaller the droplets can be applied, such as up to the size where at least one patch falls within the circumference of the applied droplets.

A method for determining binding of a first member molecule within a library of tentative first member binding molecules with a second member binding molecule is also disclosed. The method includes providing a support with spots comprising the tentative first member binding molecules, providing a second member binding molecule and detecting binding of a first member molecule with the second member binding molecule.

The binding is detected with an optically detectable marker, such as a fluorophore, that is directly or indirectly labeled to a probe. The probe may be a nucleic acid or an antibody and, thus, allows a support of the present invention to be used in any type of micro-array. By preventing diffusion, problems such as signal overload can be avoided or circumvented. Thus, one exemplary embodiment of the invention discloses a method wherein binding pairs are detected via enzyme-linked-assay techniques where diffusion or leakage can be a problem. By preventing diffusion, the enzymatic detection method disclosed herein is more sensitive and allows fewer copies of tentative first member molecules to be spotted on one spot, thus decreasing spot-size and increase spot density without losing sensitivity. The enzymatic detection may be up to 10-1,000 times more sensitive than detection using directly labeled probes.

Suitable enzyme-substrate combinations and methods for use in exemplary embodiments of the invention are, for example, found with U.S. Pat. No. 4,931,223 that discloses processes in which light of different wavelengths is simultaneously released from two or more enzymatically decomposable chemiluminescent 1,2-dioxetane compounds. The compounds are configured by means of the inclusion of a different light emitting fluorophore in each compound, such that each compound emits light of the different wavelengths by decomposing each of the compounds with a different enzyme. Also, Bronstein et al., BioTechniques 12 #5 (May 1992) pp. 748-753, “Improved Chemiluminescent Western Blotting Procedure” discloses an assay method in which a member of a specific binding pair is detected with an optically detectable reaction. The reaction includes an enzyme of a dioxetane such that the enzyme cleaves an enzyme-cleavable group from the dioxetane to form a negatively charged substituent bonded to the dioxetane. The negatively charged substituent causes the dioxetane to decompose and form a luminescent substance. Cano et al., J. App. Bacteriology 72 (1992) discloses an example of nucleic acid hybridization with a fluorescent alkaline phosphatase substrate that can also be used in the present invention, and Evangelista et al., Anal. Biochem. 203 (1992) teaches alkyl-and aryl-substituted salicyl phosphates as detection reagents in enzyme amplified fluorescence DNA hybridization assays.

As will be described herein, a fluorescent substrate for alkaline phosphatase-based detection of protein blots is used with fluorescence scanning equipment, such as Molecular Dynamics Fluorlmager or Storm instruments, generally known as Vistra ECF and typically deemed suitable for use in Western blotting, and dot and slot blotting applications. The enzymatic reaction of alkaline phosphatase dephosphorylates the ECF substrate to produce a fluorescent product which is detectable in a method of the invention. The invention also discloses a method wherein a substrate for evaluating glycosidic enzymes comprising a fluorescein derivative, such as disclosed in U.S. Pat. No. 5,208,148, is used. The substrate bears a lypophilic character and will reside in hydrophobic areas of the surface.

Another exemplary embodiment of the invention discloses a synthetic molecule comprising a binding site, i.e., located on the detected first member molecule or derivatives thereof, or a binding molecule including a binding site identifiable or obtainable by a method according to the invention. In a further exemplary embodiment of the invention, the support or methods may be used for identifying or obtaining a synthetic molecule having a binding site, or for identifying or obtaining a binding molecule capable of binding to a binding site, and the use of such an obtained molecule for interfering with or effecting binding to a binding molecule.

### BRIEF DESCRIPTION OF THE SEVERAL VIEWS OF THE DRAWINGS

FIG. 1. Surface structure of polyacrylic acid grafted polypropylene (PP).

FIG. 2. ECF-substrate wettability of different surfaces.

FIG. 3. Storm fluorescence signals of the binding of peptide nr 1,2,3 and 4 (y-axis) to Mab GO 1 using five different gridding pins (on X-axis diameter gridding pins). Four different peptide concentrations were spotted on three different grafts: 12/50 Ac, 9/30 Ac and 6/12 Ac grafts.

FIG. 4A illustrates the maximal fluorescent signals of the spots as detected by the Storm of the binding of Mab GO1 to the peptide nr 1 (SEQ ID NO: 2), 2 (SEQ ID NO: 3), 3 (SEQ ID NO: 4) and 4 (SEQ ID NO: 5) on graft 6/12 Ac using a peptide concentration of 1 mg/ml and five different gridding pins.

FIG. 4B illustrates the maximal fluorescent signals of the spots as detected by the Storm of the binding of Mab GO1 to the peptide nr 1 (SEQ ID NO: 2), 2 (SEQ ID NO: 3), 3 (SEQ ID NO: 4) and 4 (SEQ ID NO: 5) on graft 6/12 Ac using a peptide concentration of 0.2 mg/ml and five different gridding pins.

FIG. 4C illustrates the maximal fluorescent signals of the spots as detected by the Storm of the binding of Mab GO1 to the peptide nr 1 (SEQ ID NO: 2), 2 (SEQ ID NO: 3), 3 (SEQ ID NO: 4) and 4 (SEQ ID NO: 5) on graft 6/12 Ac using a peptide concentration of 0.04 mg/ml and five different gridding pins.

FIG. 4D illustrates the maximal fluorescent signals of the spots as detected by the Storm of the binding of Mab GO1 to the peptide nr 1 (SEQ ID NO: 2), 2 (SEQ ID NO: 3), 3 (SEQ ID NO: 4) and 4 (SEQ ID NO: 5) on graft 6/12 Ac using a peptide concentration of 0.08 mg/ml and five different gridding pins.

FIG. 5A illustrates maximal fluorescent signals of the spots as detected by the Storm of the binding of Mab GO 1 to peptides nr 1 (SEQ ID NO: 2), 2 (SEQ ID NO: 3), 3 (SEQ ID NO: 4) and 4 (SEQ ID NO: 5) (Peptide concentration 0.2 mg/ml) on graft 6/12 Ac.

FIG. 5B illustrates maximal fluorescent signals of the spots as detected by the Storm of the binding of Mab GO 1 to peptides nr 1 (SEQ ID NO: 2), 2 (SEQ ID NO: 3), 3 (SEQ ID NO: 4) and 4 (SEQ ID NO: 5) (Peptide concentration 0.2 mg/ml) on graft 9/30 Ac.

FIG. 5C illustrates maximal fluorescent signals of the spots as detected by the Storm of the binding of Mab GO 1 to peptides nr 1 (SEQ ID NO: 2), 2 (SEQ ID NO: 3), 3 (SEQ ID NO: 4) and 4 (SEQ ID NO: 5) (Peptide concentration 0.2 mg/ml) on graft 12/50 Ac.

FIG. 6A. Schematic presentation of a head-to-tail complete matrix scan. 12345678901 and ABCDEFGHIJK represent sequences derived from a protein and a schematic presentation of a tail-to-tail complete matrix scan. This scan is similar to the scan shown in FIG. 4, however, the cysteine residue is positioned at the N-terminus of the second building block, leading to a reversed or tail-to-tail orientation of both building blocks. Both sequences are linked as previously described. In this scan, both sequences are shifted independently through the complete protein sequence, generating a library of all possible sequence combinations.

FIG. 6B. List of all peptides (derived from hFSH) containing an N-terminal bromoacetamide group. Peptides 1) through 181) of FIG. 6B correspond to SEQ ID NOS: 6-186, respectively.

FIG. 6C. List of all peptides (derived from hFSH) containing a C- or N-terminal cysteine. Peptides 1) through 7) correspond to SEQ ID NO: 187-193, respectively; peptide 8) corresponds to SEQ ID NO: 12; peptides 9) through 16) correspond to SEQ ID NOS: 194-201, respectively; peptide 17) corresponds to SEQ ID NO: 22; peptides 18) through 20) correspond to SEQ ID NOS: 202-204, respectively; peptide 21) corresponds to SEQ ID NO: 26; peptides 22) through 31) correspond to SEQ ID NOS: 205-214, respectively; peptide 32) corresponds to SEQ ID NO: 36; peptides 33) through 48) correspond to SEQ ID NOS: 215-230, respectively; peptide 49) corresponds to SEQ ID NO: 54; peptides 50) through 59) correspond to SEQ ID NOS: 231-240, respectively; peptide 60) corresponds to SEQ ID NO: 64; peptides 61) through 70) correspond to SEQ ID NOS: 241-250, respectively; peptide 71) corresponds to SEQ ID NO: 76; peptide 72) corresponds to SEQ ID NO: 251; peptide 73) corresponds to SEQ ID NO: 78; peptides 74) through 85) correspond to SEQ ID NOS: 252-263, respectively; peptide 86) corresponds to SEQ ID NO: 89; peptides 87) through 90) correspond to SEQ ID NOS: 264-267, respectively; peptide 91) corresponds to SEQ ID NO: 95; peptides 92) through 98) correspond to SEQ ID NOS: 268-274, respectively; peptides 99) and 100) both correspond to SEQ ID NO: 103; peptides 101) and 102) correspond to SEQ ID NOS: 275-276, respectively; peptide 103) corresponds to SEQ ID NO: 107; peptides 104) through 133) correspond to SEQ ID NOS: 277-306, respectively; peptides 134) corresponds to SEQ ID NO: 137; peptides 135) and 136) correspond to SEQ ID NOS: 307 and 308, respectively; peptide 137) corresponds to SEQ ID NO: 141; peptides 138) through 152) correspond to SEQ ID NOS: 309-323, respectively; peptide 153) corresponds to SEQ ID NO: 157; peptide 154) corresponds to SEQ ID NO: 324; peptide 155) corresponds to SEQ ID NO: 159; peptides 156) through 164) correspond to SEQ ID NOS: 325-333, respectively; peptide 165) corresponds to SEQ ID NO: 169; peptides 166) through 169) correspond to SEQ ID NOS: 334-337, respectively; peptide 170) corresponds to SEQ ID NO: 173; peptides 171) through 174) corresponds to SEQ ID NOS: 338-341, respectively; peptide 175) corresponds to SEQ ID NO: 179; and peptides 176) through 183) correspond to SEQ ID NOS: 342-349, respectively.

FIG. 6D. Complete matrix scan, i.e., after coupling of all? ALL in B listed in B sequences to all? in C listed in C sequences, exemplified by cards 145-155 and a full picture of all binding values of all ca. 40,000 peptides (below). Peptide VYETVRVPGCAC$ADSLYTYPVATQ corresponds to SEQ ID NO: 350. The $ symbol refers to a bromoacetamide group.

FIG. 7A. Schematic presentation of a multi-building block scan. 12345678901 (building block 1), NOPQRSTUVWXY (building block 2) and BCDEFGHJKLM (building block 3) represent successive sequences derived from a protein. Building blocks were linked via a thioether bridge, formed by reaction of a free thiol function of a C-terminal cysteine residue (C) in building block 1 and a bromoacetamide group ($) at the N-terminus of building block 2 and so on, as described in example 3. In this scan all sequences are subsequently shifted simultaneously through the complete protein sequence to obtain the complete library.

FIG. 7B. Working example obtained with an anti-hFSH monoclonal antibody-02.

FIG. 7C. Binding values and list of peptides coupled onto each other. Peptides 1 through 36 correspond to SEQ ID NOS: 351-386, respectively. Card 6 is associated with SEQ ID NO: 356, card 07 is associated with SEQ ID NO: 357, card 08 is associated with SEQ ID NO: 358; card 09 is associated with SEQ ID NO: 359; card 0 is associated with SEQ ID NO: 360; card 11 is associated with SEQ ID NO: 361; card 12 is associated with SEQ ID NO: 362; card 13 is associated with SEQ ID NO: 363; card 1 is associated with SEQ ID NO: 371; card 22 is associated with SEQ ID NO: 372; card 35 is associated with SEQ ID NO: 385; and card 36 is associated with SEQ ID NO: 386.

FIG. 7D. One square in full detail. The peptide $CKELVYETVRVPG (SEQ ID NO: 1) was coupled to the cysteine of card 06, which is associated with SEQ ID NO: 356. The $ symbol refers to a bromoacetamide group. To this card, peptides 1 to 36 were spotted with gridding pins. The binding values are shown below. Chemistry in short: Polypropylene (PP) surface was gamma irradiated (in this case 50 kGy) in the presence of CuSO₄ and (in this case 12%) acrylic acid. Carboxylic acid functionalized PP was treated with Boc-HMDA/DCC/HOBt and subsequent treatment with trifluoracetic acid (TFA) yielded a surface with amino groups. To this amino group functionalized PP surface, N-Fmoc-S-trityl-L-cysteine (Fmoc-Cys-(Trt)-OH) was coupled using DCC and HOBt. Subsequently the Fmoc group was removed, followed by acetylation of amino group. Treatment of the surface with TFA (with triethylsilan and water as scavengers) yielded a thiol functionalized surface. Bromoacetyl (or other thiol reactive) containing peptides were allowed to react with the thiol groups of the PP surface in 0.015 M NaHCO₃ (pH 7-8, overnight reaction). Subsequently, the StBu groups (of the S-t-butylthio protected Cys residues) of the coupled peptides were removed using NaBH₄ (14 mg/ml in 0.015 M NaHCO₃ pH 7-8, 30 min, 30° C.), generating new thiol groups in the peptides. A second set of Bromoacetyl (or other thiol reactive) containing peptides were allowed to couple to the first set, making peptide constructs. This process can be repeated several times using different sets of bromoacetylated peptides. Peptides 1 through 36 correspond to SEQ ID NOS: 351-386, respectively.

FIG. 8. Storm fluorescence signals of the binding of Glu-ox to Mab GO1 on 3 different grafts using five different gridding pins.

FIG. 9. On a matrix-scan of human Follicle-Stimulating Hormone (hFSH), the polyclonal anti-hFSH serum R5125 (Biotrent 4560-5215) was tested at 1 ug/ml. The matrix included four large squares (left side of the picture). Each large square contains 48 smaller squares. To the thiol group functionalized surfaces of each of these 48 squares (on all the four plates), one bromoacetylated hFSHpeptide (or a control peptide) is coupled via its bromoacetyl groups as described herein. In this way, each of the overlapping 13-mer peptides covering hFSH are coupled, generating 181 overlapping hFSH peptide functionalized squares+11 control peptide squares. All peptides possess a cysteine with a thiol protecting tert-butylsulfenyl group (Cys(StBu)). The same set of bromoacetylated hFSH peptides can be coupled to each peptide functionalized small square when the protecting StBu groups of the peptides on the peptide functionalized surfaces is removed by treatment of NaBH4 in aqueous environment at pH 7-8. Within each peptide functionalized square all bromoacetylated hFSH overlapping peptides are spotted generating, after coupling, 181 26-mer hFSH peptide constructs (spots) within each peptide functionalized square. In this way a matrix-scan is generated of all 32,761 (181*181) overlapping FSH 26-mer peptide constructs. The position of the cysteine (Cys(StBu)) in the peptides, used for coupling, varies. Peptide 1 (first 13-mer of hFSH=1-12Cys) has a Cys(StBu) on its C-terminal end, peptide 2 (peptide Cys2-13 of hFSH) contains a Cys(StBu) on the N-terminal site of the peptide while peptide 3 (peptide 3-14Cys of hFSH) again has a Cys(StBu) on its C-terminal end. Peptide 4 (peptide Cys4-15 of hFSH) has again an N-terminal Cys(StBu) and so on. Peptide 1 is coupled to the left top small square of the left top large square, peptide 2 is coupled to the left top small square, one step to the right, of the left top large square, peptide 3 is coupled to the left top small square, two steps to the right, of the left top large square and so on. The two enlarged squares on the right side of the figure show binding of antibody R5125 to peptide constructs on peptide functionalized square no.150 (upper enlarged square =peptide 150-162Cys of hFSH) and peptide functionalized square no.66 (lower enlarged square =peptide Cys66-78 of hFSH). A black color represents binding of antibody to peptide (black square) or peptide constructs (black spots). In the lower enlarged square, the first spot (left top) indicates binding of the antibody to a control peptide construct, the next spot to the right represents binding to a peptide construct containing peptide no. 1 (hFSH 1-12Cys(StBu)) coupled to hFSH Cys66-78 in lower enlarged square, again one spot to the right shows binding of the antibody to peptide construct hFSH Cys(StBU)2-13 with hFSH Cys66-78 and so on. White spots represent less binding of the antibody to the peptide construct compared to the binding of the antibody to the peptide within the square. No visible spots represent equal binding of the antibody to the peptide constructs compared to the binding of the peptide within the squares.

### DETAILED DESCRIPTION OF THE INVENTION

The micro-array support and methods of the present invention may be used to detect binding of peptides, nucleic acids or other biomolecules. Conventional Pepscan methods use pins (Geysen et al.) or wells (Slootstra et al.). Polyacrylic acid grafts or other acrylic grafts on the polyethylene pins or in the polypropylene wells were used as carriers of peptides. Due to the high peptide loadings (each other carbon atom of the polymer can in theory carry a peptide) tested in an ELISA format, extreme low binding-interactions of a peptide to an antibody can be detected (detection of kD<3 M are possible). In this system, the interactions were separated physically, i.e., by walls of wells. Technically, miniaturization of this concept stops at approximately 10 wells/cm² due to the limitations of conventional (syringe /needle) liquid handling techniques in practice. When the set-up is miniaturized, it is desirable to keep the two strongholds (high peptide loadings in combination with enzyme-linked detection methods) intact.

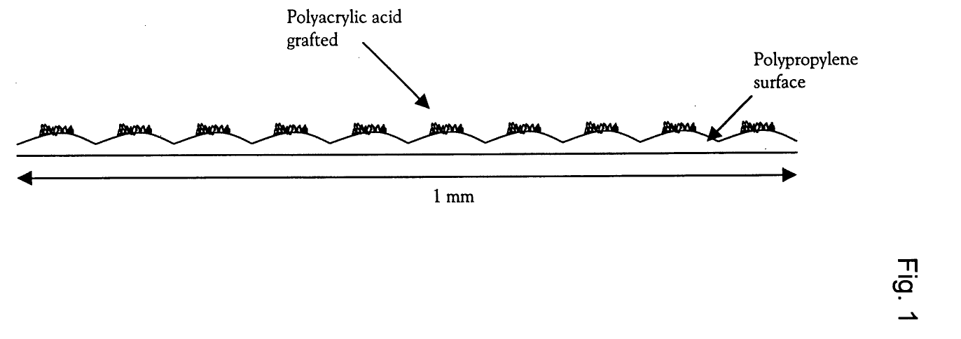

Rough polypropylene (PP) supports are commercially available and are widely used as non-shiny material in all sorts of applications. The rough PP appeared to be an ideal template for attaching polyacrylic acid grafts. For example, microscope viewing of PP (EVACAST 1070 N16; Vink Kunststoffen BV) surfaces reveal rounded elevations (hills) separated by tiny depressions (valleys) (See, FIG. 1). The PP surface on top of the hills is relatively rough compared to the surface of valleys between the hills. The rough surface appeared to be a good scaffold for attaching grafts whereas the depressions accept grafts less readily. Thus, during grafting procedures using gamma irradiation, the graft is not regularly dispersed along the surface, but is deposited in patches surrounded by materially different areas corresponding to the depressions in the material. For example, using CuSO₄ and acrylic acid during grafting, most of the polyacrylic acid polymers are grafted on the top of the elevations and less in the depressions (See, FIG. 1). Thus, a more-or-less regular pattern of hydrophilic (polyacrylic acid grafts) patches and relatively hydrophobic (places without or less polyacrylic acid grafts) areas are present on the grafted PP surface.

The pattern of hydrophilic (normally hydrophilic matrixes cause severe diffusion) and hydrophobic areas (blocks diffusion) diminish diffusion, especially when the patches are smaller then the droplet size of dispensed material. Although the surface of the PP is not completely covered with a homogenous graft, high loadings of peptide/cm² are possible due to the relatively high surface occupation of the polyacrylic acid grafts on the PP surfaces. In the above described setup, thicker grafts can carry higher peptide loadings, but will suffer from more diffusion problems of dispensed material because of the growing occupation of grafted surface. However, the material can be made to suit various needs as regard to loading versus diffusion.

Enzyme-linked assays use substrates which are converted by the enzyme in products that precipitate in situ or are water soluble. A drawback of precipitating products is the non-reusability of the system caused by insolubility of the precipitated material during cleaning. The set up that makes use of non precipitating products, in particular non precipitating products which are fluorescent, because of the ease of detection by modern fluorescent signal detecting applications is desirable. When substrates (developing soluble products) are put on the surface, such as where excess of substrate material is in a later stage removed from the surface, dye development does not suffer from diffusion problems. This phenomenon is caused by the valley/hill or hydrophobic/hydrophilic construction of the surface in combination with excellent wettability properties of the polyacrylic acid matrix.

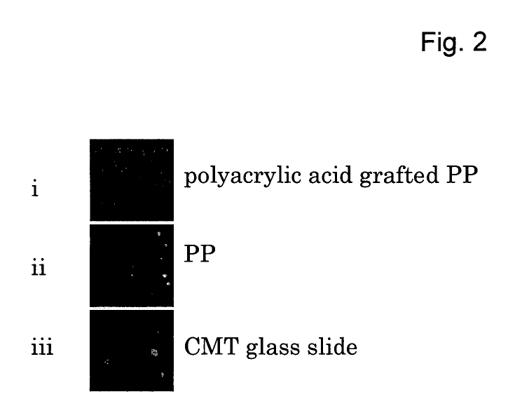

FIG. 2 shows the Vistra ECF (2′(2-benzthiazoyl }-6′-hydroxy-benzthiozole phosphate bis-(2-amino-2-methyl-1,3-propanediol) salt; Amersham Pharmacia Biotech) substrate wettability of i) with and ii) without poly acrylic acid grafted PP (EVACAST 1070 N16; Vink Kunststoffen BV) and iii) CMT-glass slides (Corning) as detected on a Storm Fluorimager (Molecular Dynamics). Although the polyacrylic acid grafted PP-EVACAST surface is not continuously occupied with porous (polyacrylic acid grafts) material, the Storm Fluorimager does not detect irregular surface patterns. This is in contrast to un-grafted PP-EVACAST or CMT-glass slides.

### EXAMPLES

### Example 1

A polypropylene (PP) support (EVACAST 1070 N16; Vink Kunststoffen BV) was grafted with acrylic acid to introduce polyacrylic acid grafts on the PP surface. In this case, the solid PP support was irradiated in the presence of 6%, 9% or 12% acrylic acid solutions in water containing CuSO4 using gamma radiation at a dose of 12, 30 or 50 kGy (combinations: 6% acrylic acid and 12kGy=6/12 Ac; 9% acrylic acid with 30 kGy=9/30 Ac and 12% acrylic acid with 50 kGy=12/50 Ac). The grafted solid support containing carboxylic acid groups was functionalized with amino groups via coupling of t-butyloxycarbonylhexamethylenediamine (Boc-HMDA) using dicyclohexylearbodiimide (DCC) with N-hydroxybenztriazole (HOBt) and subsequent cleavage of the Boc groups using trifluoracetic acid. To introduce a thiol reactive bromacetamide group on the support, the amino group functionalized support was treated with bromoacetic acid using DCC or DCC/HOBt.

Peptides containing cysteine residues were able to couple to the bromo functionalized surface via the thiol group of the cysteine residues forming a stable thioether bond. Peptides were spotted on the bromo functionalized surface using gridding pins (Genomic Solutions) with different diameters (1.5 mm, 0.8 mm, 0.6 mm, 0.4 mm and 0.25 mm). Solutions with different concentrations of peptide were used (1 mg/ml, 0.2 mg/ml, 0.04 mg/ml and 0.008 mg/ml). When aliquots of peptide solutions (in bicarbonate buffer at about pH 7-8) were dispensed on the support using the gridding pins, the coupling of the bromo group on the surface to the thiol group of the peptide was achieved in a humid chamber (overnight reaction). Extensive washing removed uncoupled peptide.

Peptides used included: GCASLQGMDTCGK (Nr1) (SEQ ID NO: 2), CAFKQGVDTCGK (Nr2) (SEQ ID NO: 3), APDPFQGVDTCGK (Nr3) (SEQ ID NO: 4), and GCAPDPFQGVDTCGK (Nr4) (SEQ ID NO: 5). From surface plasmon resonance (SPR) measurements, affinity constants are known with antibody Mab GO1: Nr1 kD=<10-3; Nr2 kD=3.10-7; Nr3 kD=4.10-6; and Nr4 kD=6.10-8.

Binding of the antibody to the peptides was detected using a method that made use of a fluorescent product. The whole PP support containing the peptide functionalized areas was incubated with the antibody (Mab GO1 5 ug/ml, incubation overnight). After washing, a subsequent incubation of a second anti-mouse antibody conjugated to alkaline phosphatase introduces, after binding of the Mab to the peptide, the enzyme alkaline phosphatase at the peptide functionalized surface (spots). After washing, the bound enzyme caused fluorescent product signals at the peptide functionalized surfaces when a thin film of a Vistra ECF substrate (Amersham Pharmnacia Biotech) solution was added to the surface (excess substrate was removed). Fluorescent product signals could be quantified on a Storm (Molecular Dynamics) in blue fluorescent mode.

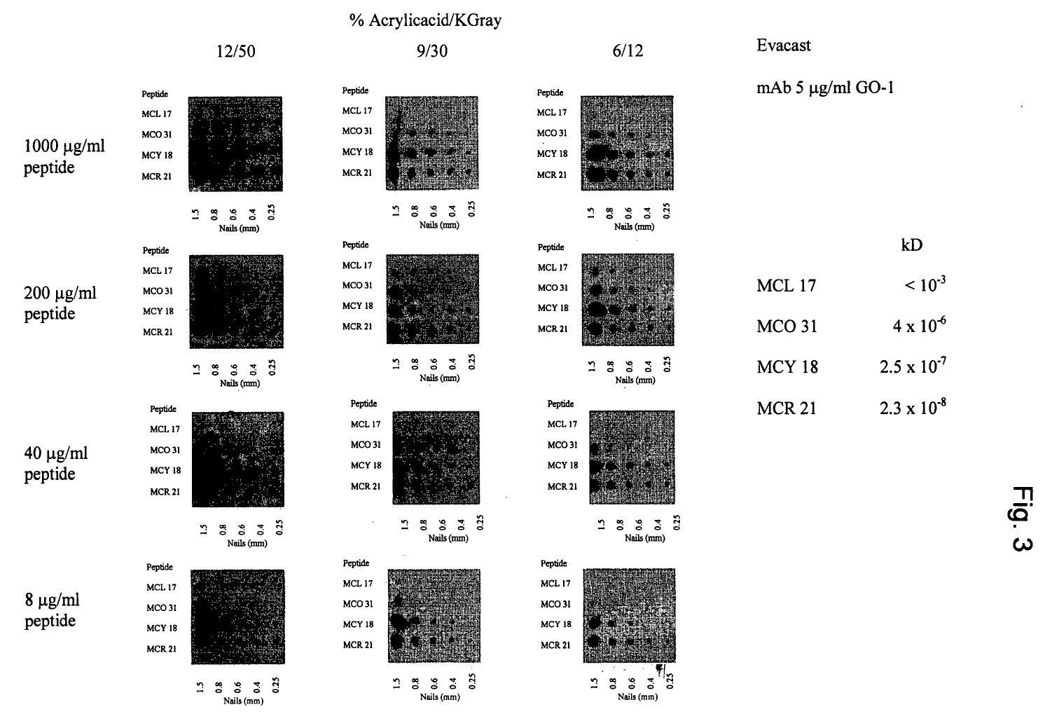

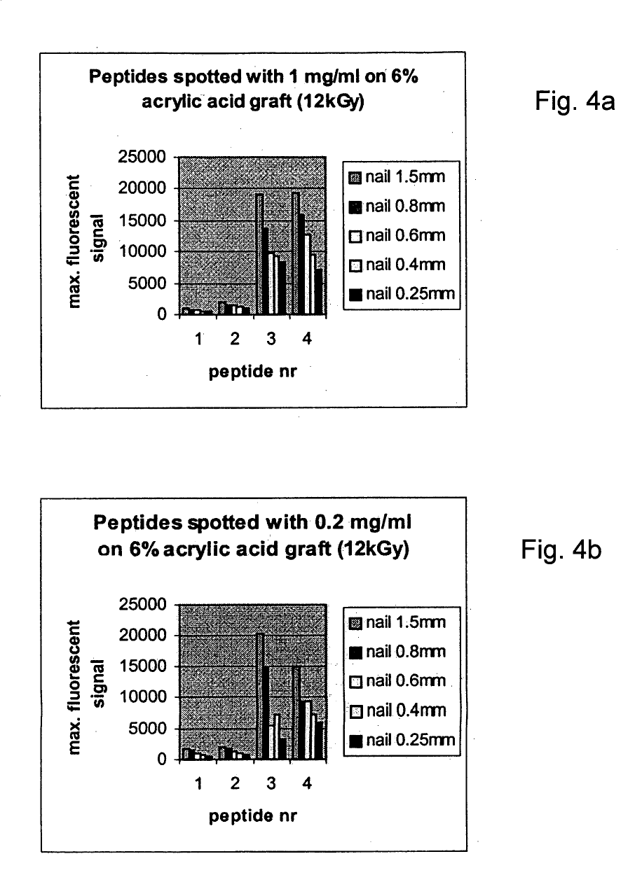

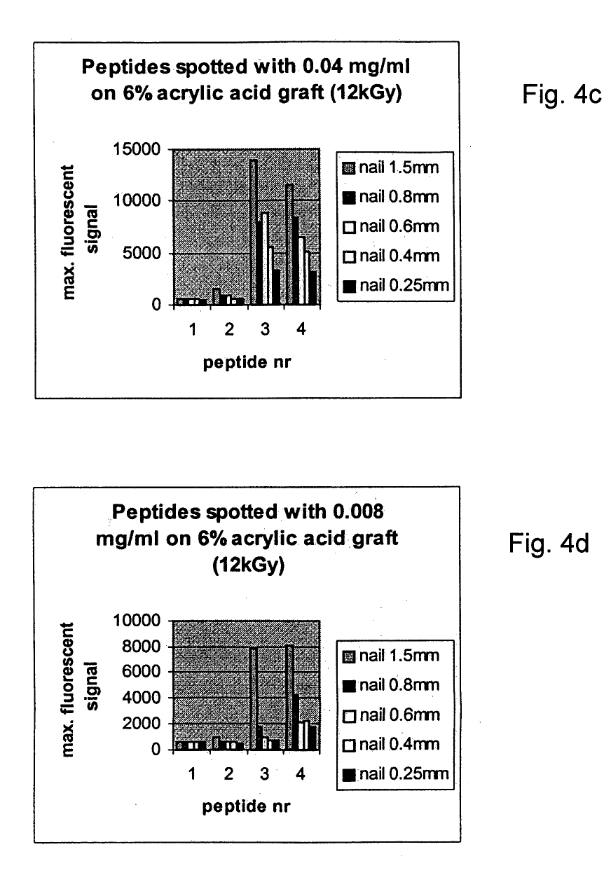

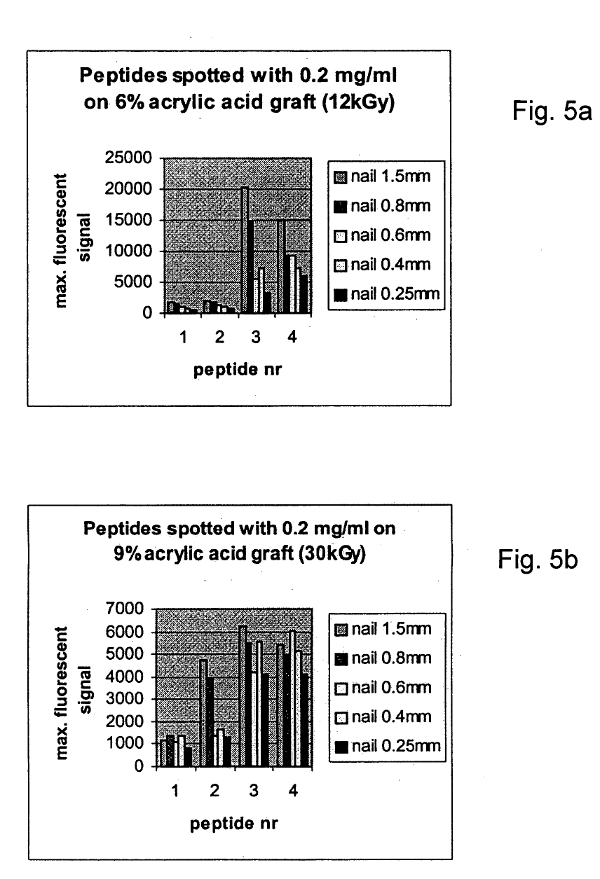

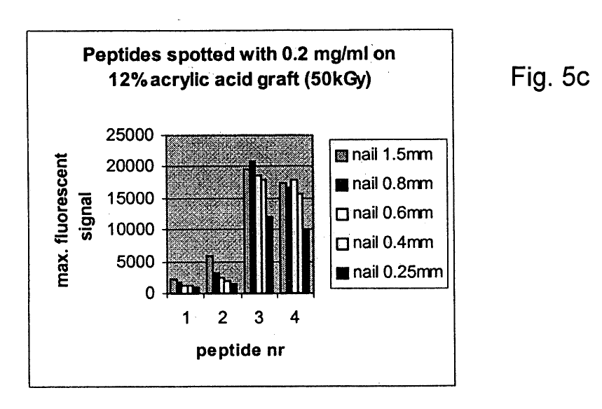

FIG. 3 shows the Storm fluorescent signals of the binding of the peptides Nr 1 (SEQ ID NO: 2), 2 (SEQ ID NO: 3), 3 (SEQ ID NO: 4) and 4 (SEQ ID NO: 5) to Mab GO1 using five different gridding pins and four different peptide concentrations on 3 different grafts. FIGS. 4A-4D show the maximal fluorescent signals of the spots on graft 6/12 Ac. FIG. 5 shows the maximal fluorescent signals of peptides Nr 1 (SEQ ID NO: 2), 2 (SEQ ID NO: 3), 3 (SEQ ID NO: 4) and 4 (SEQ ID NO: 5) spotted with 0.2 mg/ml on graft 6/12 Ac, 9/30 Ac and 12/50 Ac.

### Example 2

Glucose Oxidase. A polypropylene (PP) support (EVACAST 1070 N16; Vink Kunststoffen BV) was grafted with polyacrylic acid. The solid support was irradiated in the presence of 6% acrylic acid solution in water containing CuSO4 using gamma radiation at a dose of 12kGy. The grafted solid support containing carboxylic acid groups was functionalized with amino groups via coupling of t-butyloxycarbonylhexamethylenediamine (Boc-HMDA) using dicyclohexylcarbodiimide (DCC) with N-hydroxybenztriazole (HOBt) and subsequent cleavage of the Boc groups using trifluoracetic acid. To introduce a thiol reactive bromacetamide group on the support, the amino group functionalized support was treated with bromoacetic acid using DCC or DCC/HOBt.

Glucose oxidase containing thiol-groups (Glu-ox-SH) was able to couple to the bromo functionalized surface. Thiol groups on Glucose oxidase (Glu-ox; 1 mg/ml) were introduced in 0.16 M borate buffer (pH 8) using 2-iminothiolane (5 times molar excess 2-iminothiolane over Glu-ox; 45 min at room temperature). Glu-ox-SH was spotted on the bromo functionalized surface using gridding pins (Genomic Solutions) with different diameters (1.5 mm, 0.8 mm, 0.6 mm, 0.4 mm and 0.25 mm). Concentration of Glu-ox-SH was 0.25 mg/ml. When aliquots of Glu-ox-SH solutions (in phosphate buffered saline (PBS), 1 mM Titriplex=EDTA at pH 7) were dispensed on the support using the gridding pins, the coupling of the bromo group of the surface to the thiol group of Glu-ox-SH was achieved in a humid chamber (overnight reaction). Extensive washing removed uncoupled Glu-ox-SH.

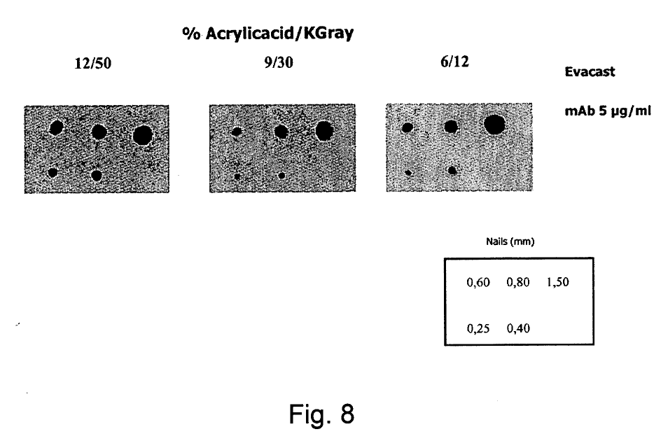

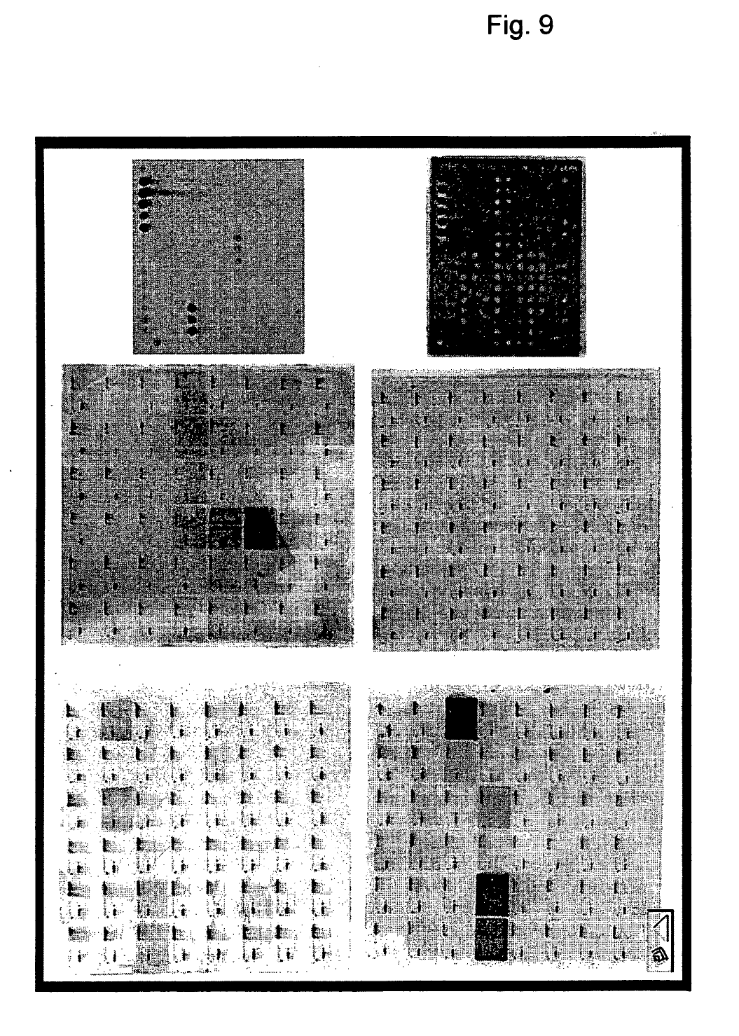

Binding of an antibody (Mab G01) to Glu-ox was detected using a method that made use of a fluorescent product. The whole PP support containing the Glu-ox functionalized areas was incubated with the antibody GO1 (5 ug/ml). After washing, a subsequent incubation of a second anti mouse antibody conjugated to alkaline phosphatase introduces, after binding of the Mab to Glu-ox, the enzyme alkaline phosphatase at the Glu-ox functionalized surface (spots). After washing, the bound enzyme caused fluorescent product signals at the peptide functionalized surfaces when Vistra ECF substrate (Amersham Pharmacia Biotech) (excess substrate was removed) was introduced. Fluorescent product signals could be quantified on a Storm (Molecular Dynamics) in blue fluorescent mode. FIG. 8 shows the Storm fluorescent signals of the binding Glu-ox to Mab GO1 using five different gridding pins and three different grafts.

### Example—3A

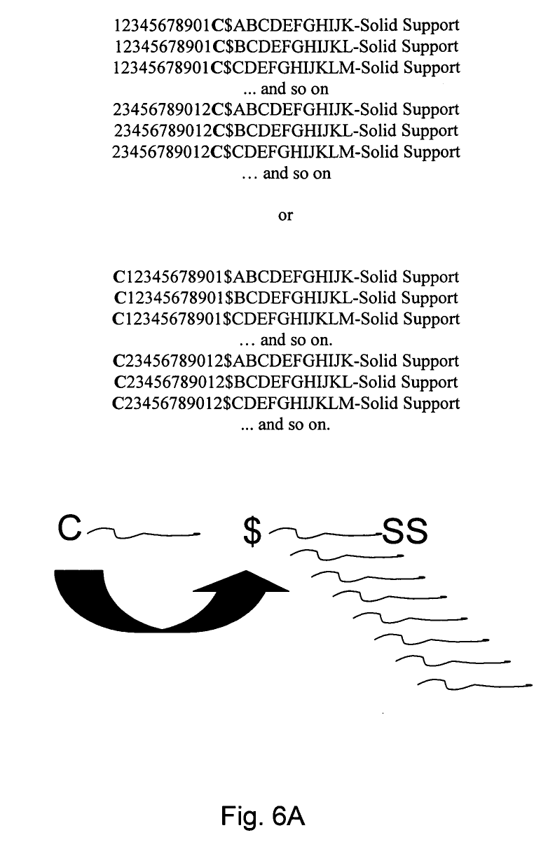

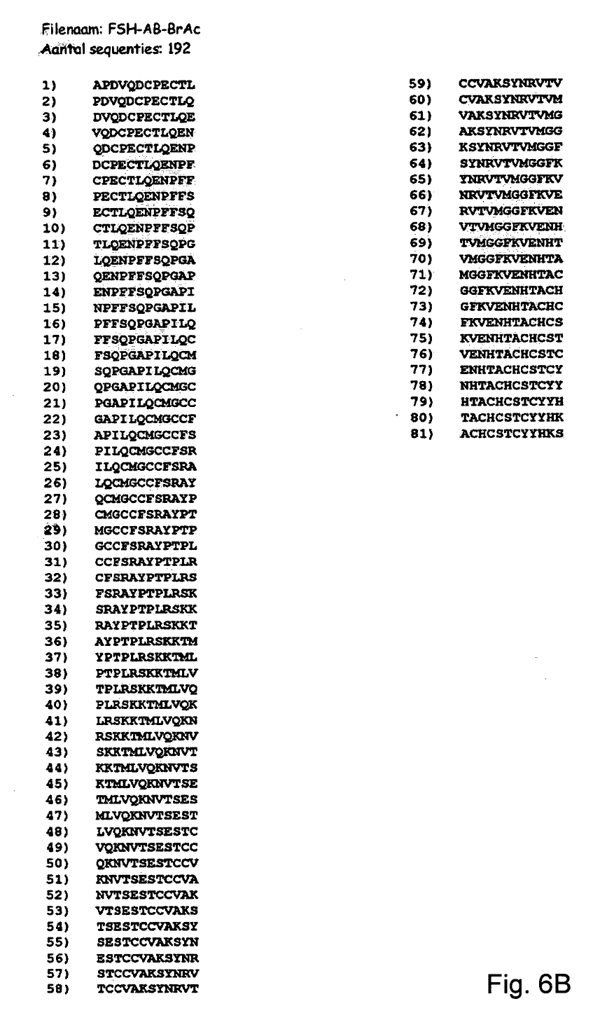

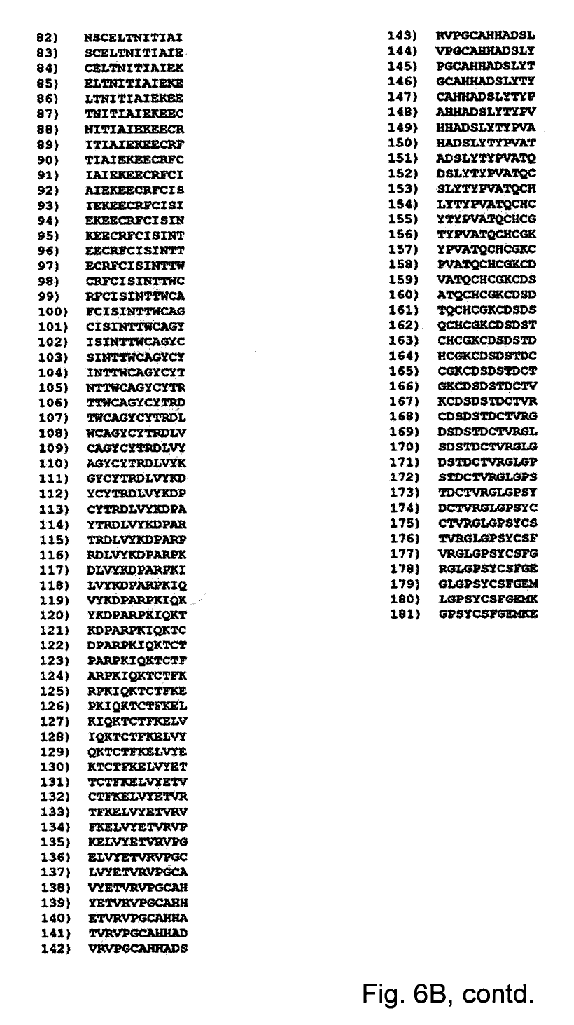

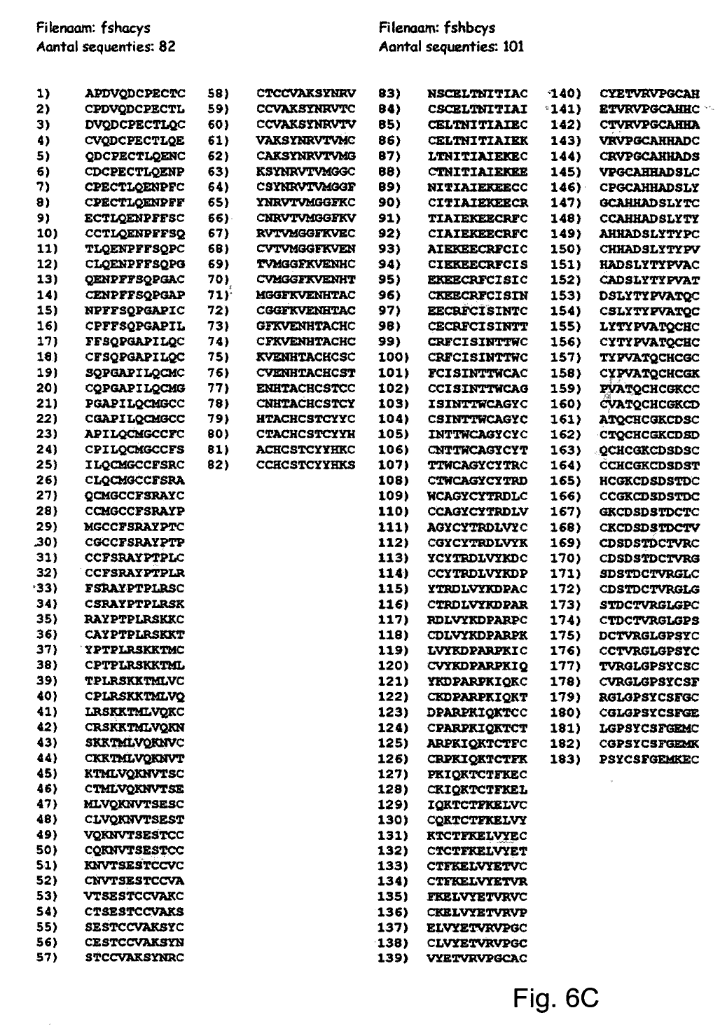

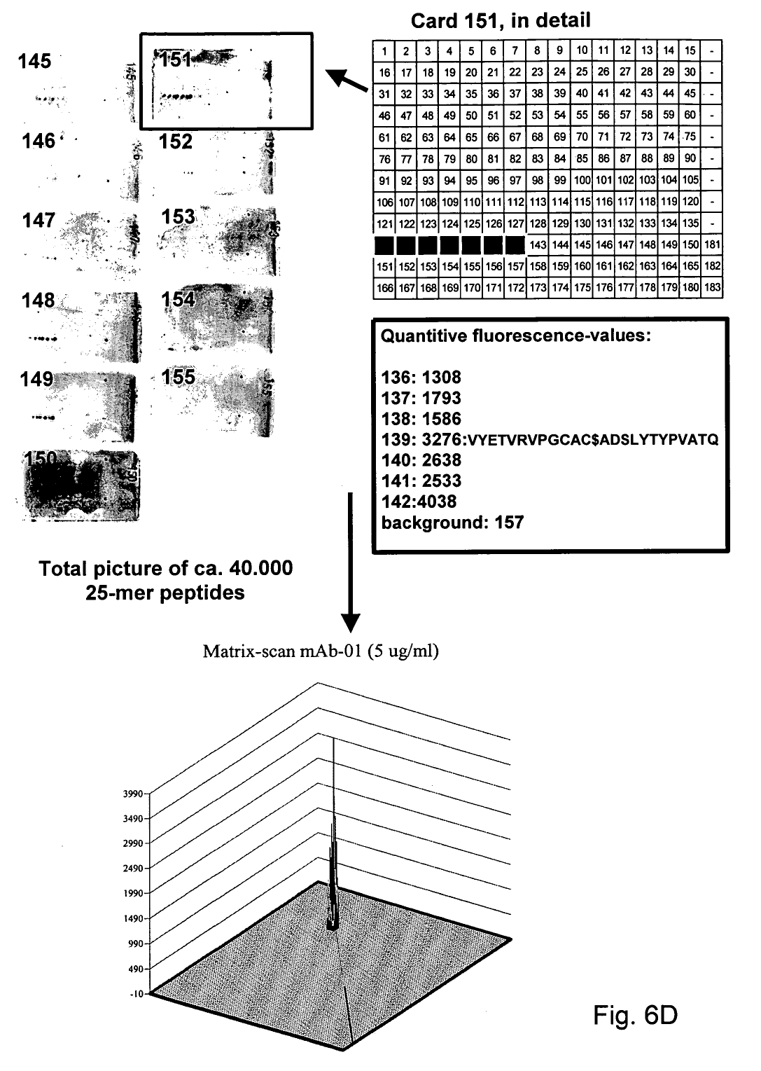

Head-to-tail matrix-scan. In a complete matrix-scan, the N-terminal sequence of, for instance, sequence (1-11) of a protein is linked as a building block with each overlapping peptide sequence of a complete scan of the same protein as shown in FIG. 6A. Sequence (2-12) is linked with the same set of overlapping sequences and so on. The link can be formed, for instance, by reaction of a cysteine at the C-terminus of the second building block with a bromoacetamide modified N-terminus of the first building block. This means that every combination of, for instance, undecapeptides from the protein sequence is synthesized on a separate, known, position of the solid support.

### Example—3B

(Type II): Tail-to-tail matrix-scan. This is the same scan as the complete matrix scan from Example 3A, however, in this scan, the cysteine of the second building block is located at its N-terminus and provides a reversed or tail-to-tail orientation of both building blocks in the construct as shown in FIG. 6A. Examples 3A and 3B are illustrated in FIGS. 6B, 6C and 6D.

### Example—4

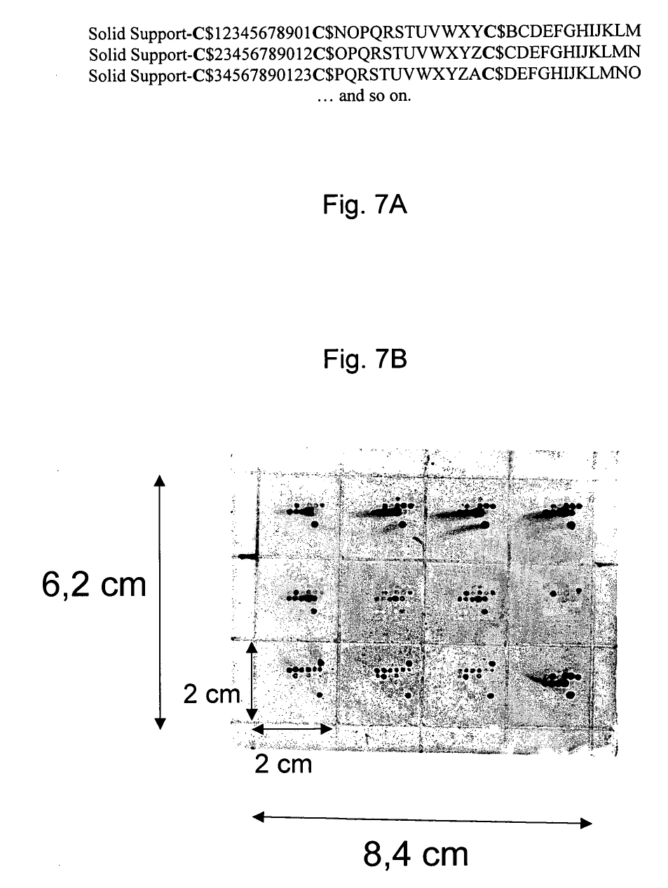

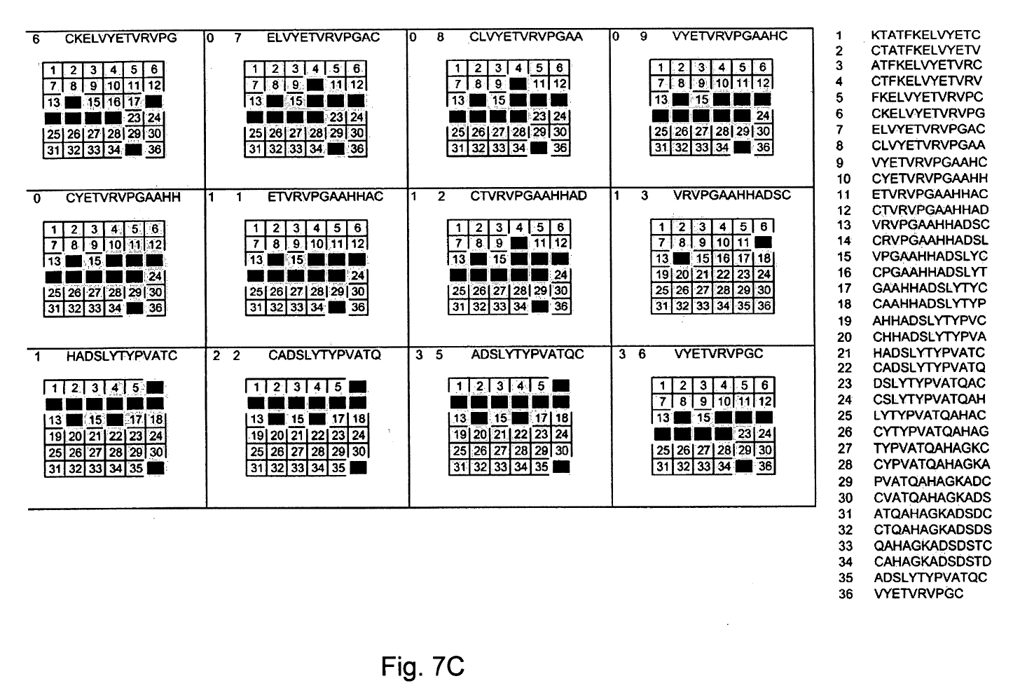

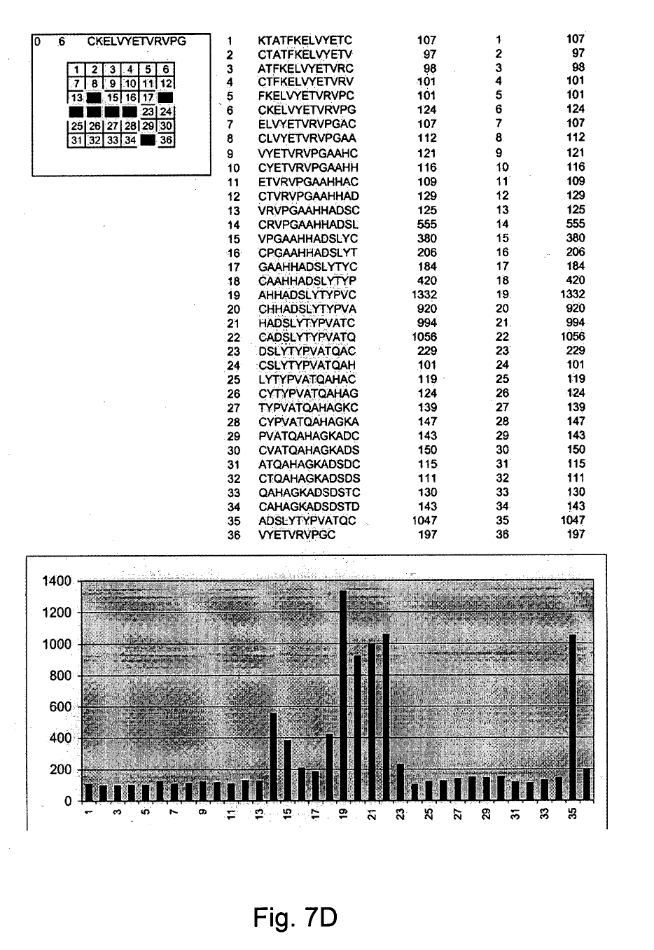

Multi building block scan. In this example, a thiol function is introduced on an amino-functionalized solid support. This can be made by a direct reaction of the amino groups with, for instance, iminothiolane, or by coupling of Fmoc-Cys(Trt)-OH, followed by Fmoc cleavage using piperidine, acetylation, and trityl deprotection using TFA/scavenger mixtures. This thiol-functionalized solid support can be reacted with, for instance, a bromoacetamide-peptide, containing a protected cysteine residue. After coupling of the first peptide, the cysteine can be deprotected using, for instance, a TFA/scavenger mixture. The formed free thiol group can be used to couple a second bromoacetamide-peptide, again containing a protected cysteine. This procedure can be repeated to make multi-building block constructs. Several types of scans, as described in the other examples, can be used in combination with this multi building block scan. In FIG. 7A, an example is shown for a three multi building block scan. A working example with two building block scans is illustrated in FIGS. 7B, 7C and 7D.

### REFERENCES

Frank R. Strategies and techniques in simultaneous solid phase synthesis based on the segmentation of membrane type supports. Bioorganic and Medical Chemistry Letters, 1993 Vol. 3 Number 3 pages 425-430.
Geysen H. M., Meloen R. H. and Barteling S. J. (1984). Use of peptide synthesis to probe viral antigens for epitopes to a resolution of a single amino acid. Proc. Natl. Acad. Sci. USA 81, 3998-4002.
Slootstra J. W., Puijk W. C. Ligtvoet G. J., Langeveld J. P. M. & Meloen R.H. 1995. Structural aspects of antibody-antigen interaction revealed through small random peptide libraries. Molecular Diversity 1, 87-96.
Slootstra J W, Puijk W C, Ligtvoet G J, Kuperus D, Schaaper W M M, Meloen R H. 1997. Screening of a small set of random peptides: A new strategy to identify peptides that mimic epitopes. J. Mol. Recog. 10:219-224.

1-6. (canceled)

7. A process for determining binding of a first member molecule within a library of tentative first member binding molecules with a second member binding molecule, the process comprising:
providing a micro-array support with positioned droplets or spots comprising the tentative first member binding molecules, the micro-array support comprising:
a support surface having surface areas; and
surface patches interspersed within the surface areas;
wherein the surface areas are materially distinct from the surface patches and wherein the patches are smaller in at least one or two dimensions than the size of the circumference of the positioned droplets or spots;
providing a second member binding molecule; and
detecting binding of the first member molecule with the second member binding molecule.

8. The process according to claim 7, wherein the binding is detected with an optically detectable marker.

9. The process according to claim 8, wherein the optically detectable marker comprises a fluorophore.

10. The process according to claim 9, wherein the binding is detected with an enzyme-linked-assay.

11. The process according to claim 10, wherein the enzyme-linked-assay comprises the production of a fluorescent substrate.

12. The process according to claim 11, wherein an enzyme of the enzyme-linked-assay comprises alkaline phosphatase.

13. The process according to claim 7, wherein the library of spots includes a density of at least twenty-five spots per square centimeter on the support surface of the micro-array support.

14-23. (canceled)

24. A process for identifying or obtaining a synthetic molecule having a binding site, the process comprising:
providing a micro-array support with positioned droplets or spots comprising the tentative first member binding molecules, the micro-array support comprising:
a support surface having surface areas; and
surface patches interspersed within the surface areas;
wherein the surface areas are materially distinct from the surface patches and wherein the patches are smaller in at least one or two dimensions than the size of the circumference of the positioned droplets or spots;
providing a second member binding molecule; and
detecting binding of the first member molecule with the second member binding molecule.

25. A process for identifying or obtaining a binding molecule capable of binding to a binding site, the process comprising:
providing a micro-array support with positioned droplets or spots comprising the tentative first member binding molecules, the micro-array support comprising:
a support surface having surface areas; and
surface patches interspersed within the surface areas;
wherein the surface areas are materially distinct from the surface patches and wherein the patches are smaller in at least one or two dimensions than the size of the circumference of the positioned droplets or spots;
providing a second member binding molecule; and
detecting binding of the first member molecule with the second member binding molecule.

26. (canceled)


SEQUENCE LISTING (386 sequences)

SEQ ID NO: 1 - protein, 14 aa, artificial sequence
  artificial peptide building block
  MISC_FEATURE (1)..(1): Xaa represents a bromoacetamide group
XCKELVYETVRVPG

SEQ ID NO: 2 - protein, 13 aa, artificial sequence
  artificial peptide Nr1
GCASLQGMDTCGK

SEQ ID NO: 3 - protein, 12 aa, artificial sequence
  Artificial peptide Nr2
CAFKQGVDTCGK

SEQ ID NO: 4 - protein, 13 aa, artificial sequence
  artificial peptide Nr3
APDPFQGVDTCGK

SEQ ID NO: 5 - protein, 15 aa, artificial sequence
  artificial peptide Nr4
GCAPDPFQGVDTCGK

SEQ ID NO: 6 - protein, 12 aa, Homo sapiens
APDVQDCPECTL

SEQ ID NO: 7 - protein, 12 aa, Homo sapiens
PDVQDCPECTLQ

SEQ ID NO: 8 - protein, 12 aa, Homo sapiens
DVQDCPECTLQE

SEQ ID NO: 9 - protein, 12 aa, Homo sapiens
VQDCPECTLQEN

SEQ ID NO: 10 - protein, 12 aa, Homo sapiens
QDCPECTLQENP

SEQ ID NO: 11 - protein, 12 aa, Homo sapiens
DCPECTLQENPF

SEQ ID NO: 12 - protein, 12 aa, Homo sapiens
CPECTLQENPFF

SEQ ID NO: 13 - protein, 12 aa, Homo sapiens
PECTLQENPFFS

SEQ ID NO: 14 - protein, 12 aa, Homo sapiens
ECTLQENPFFSQ

SEQ ID NO: 15 - protein, 12 aa, Homo sapiens
CTLQENPFFSQP

SEQ ID NO: 16 - protein, 12 aa, Homo sapiens
TLQENPFFSQPG

SEQ ID NO: 17 - protein, 12 aa, Homo sapiens
LQENPFFSQPGA

SEQ ID NO: 18 - protein, 12 aa, Homo sapiens
QENPFFSQPGAP

SEQ ID NO: 19 - protein, 12 aa, Homo sapiens
ENPFFSQPGAPI

SEQ ID NO: 20 - protein, 12 aa, Homo sapiens
NPFFSQPGAPIL

SEQ ID NO: 21 - protein, 12 aa, Homo sapiens
PFFSQPGAPILQ

SEQ ID NO: 22 - protein, 12 aa, Homo sapiens
FFSQPGAPILQC

SEQ ID NO: 23 - protein, 12 aa, Homo sapiens
FSQPGAPILQCM

SEQ ID NO: 24 - protein, 12 aa, Homo sapiens
SQPGAPILQCMG

SEQ ID NO: 25 - protein, 12 aa, Homo sapiens
QPGAPILQCMGC

SEQ ID NO: 26 - protein, 12 aa, Homo sapiens
PGAPILQCMGCC

SEQ ID NO: 27 - protein, 12 aa, Homo sapiens
GAPILQCMGCCF

SEQ ID NO: 28 - protein, 12 aa, Homo sapiens
APILQCMGCCFS

SEQ ID NO: 29 - protein, 12 aa, Homo sapiens
PILQCMGCCFSR

SEQ ID NO: 30 - protein, 12 aa, Homo sapiens
ILQCMGCCFSRA

SEQ ID NO: 31 - protein, 12 aa, Homo sapiens
LQCMGCCFSRAY

SEQ ID NO: 32 - protein, 12 aa, Homo sapiens
QCMGCCFSRAYP

SEQ ID NO: 33 - protein, 12 aa, Homo sapiens
CMGCCFSRAYPT

SEQ ID NO: 34 - protein, 12 aa, Homo sapiens
MGCCFSRAYPTP

SEQ ID NO: 35 - protein, 12 aa, Homo sapiens
GCCFSRAYPTPL

SEQ ID NO: 36 - protein, 12 aa, Homo sapiens
CCFSRAYPTPLR

SEQ ID NO: 37 - protein, 12 aa, Homo sapiens
CFSRAYPTPLRS

SEQ ID NO: 38 - protein, 12 aa, Homo sapiens
FSRAYPTPLRSK

SEQ ID NO: 39 - protein, 12 aa, Homo sapiens
SRAYPTPLRSKK

SEQ ID NO: 40 - protein, 12 aa, Homo sapiens
RAYPTPLRSKKT

SEQ ID NO: 41 - protein, 12 aa, Homo sapiens
AYPTPLRSKKTM

SEQ ID NO: 42 - protein, 12 aa, Homo sapiens
YPTPLRSKKTML

SEQ ID NO: 43 - protein, 12 aa, Homo sapiens
PTPLRSKKTMLV

SEQ ID NO: 44 - protein, 12 aa, Homo sapiens
TPLRSKKTMLVQ

SEQ ID NO: 45 - protein, 12 aa, Homo sapiens
PLRSKKTMLVQK

SEQ ID NO: 46 - protein, 12 aa, Homo sapiens
LRSKKTMLVQKN

SEQ ID NO: 47 - protein, 12 aa, Homo sapiens
RSKKTMLVQKNV

SEQ ID NO: 48 - protein, 12 aa, Homo sapiens
SKKTMLVQKNVT

SEQ ID NO: 49 - protein, 12 aa, Homo sapiens
KKTMLVQKNVTS

SEQ ID NO: 50 - protein, 12 aa, Homo sapiens
KTMLVQKNVTSE

SEQ ID NO: 51 - protein, 12 aa, Homo sapiens
TMLVQKNVTSES

SEQ ID NO: 52 - protein, 12 aa, Homo sapiens
MLVQKNVTSEST

SEQ ID NO: 53 - protein, 12 aa, Homo sapiens
LVQKNVTSESTC

SEQ ID NO: 54 - protein, 12 aa, Homo sapiens
VQKNVTSESTCC

SEQ ID NO: 55 - protein, 12 aa, Homo sapiens
QKNVTSESTCCV

SEQ ID NO: 56 - protein, 12 aa, Homo sapiens
KNVTSESTCCVA

SEQ ID NO: 57 - protein, 12 aa, Homo sapiens
NVTSESTCCVAK

SEQ ID NO: 58 - protein, 12 aa, Homo sapiens
VTSESTCCVAKS

SEQ ID NO: 59 - protein, 12 aa, Homo sapiens
TSESTCCVAKSY

SEQ ID NO: 60 - protein, 12 aa, Homo sapiens
SESTCCVAKSYN

SEQ ID NO: 61 - protein, 12 aa, Homo sapiens
ESTCCVAKSYNR

SEQ ID NO: 62 - protein, 12 aa, Homo sapiens
STCCVAKSYNRV

SEQ ID NO: 63 - protein, 12 aa, Homo sapiens
TCCVAKSYNRVT

SEQ ID NO: 64 - protein, 12 aa, Homo sapiens
CCVAKSYNRVTV

SEQ ID NO: 65 - protein, 12 aa, Homo sapiens
CVAKSYNRVTVM

SEQ ID NO: 66 - protein, 12 aa, Homo sapiens
VAKSYNRVTVMG

SEQ ID NO: 67 - protein, 12 aa, Homo sapiens
AKSYNRVTVMGG

SEQ ID NO: 68 - protein, 12 aa, Homo sapiens
KSYNRVTVMGGF

SEQ ID NO: 69 - protein, 12 aa, Homo sapiens
SYNRVTVMGGFK

SEQ ID NO: 70 - protein, 12 aa, Homo sapiens
YNRVTVMGGFKV

SEQ ID NO: 71 - protein, 12 aa, Homo sapiens
NRVTVMGGFKVE

SEQ ID NO: 72 - protein, 12 aa, Homo sapiens
RVTVMGGFKVEN

SEQ ID NO: 73 - protein, 12 aa, Homo sapiens
VTVMGGFKVENH

SEQ ID NO: 74 - protein, 12 aa, Homo sapiens
TVMGGFKVENHT

SEQ ID NO: 75 - protein, 12 aa, Homo sapiens
VMGGFKVENHTA

SEQ ID NO: 76 - protein, 12 aa, Homo sapiens
MGGFKVENHTAC

SEQ ID NO: 77 - protein, 12 aa, Homo sapiens
GGFKVENHTACH

SEQ ID NO: 78 - protein, 12 aa, Homo sapiens
GFKVENHTACHC

SEQ ID NO: 79 - protein, 12 aa, Homo sapiens
FKVENHTACHCS

SEQ ID NO: 80 - protein, 12 aa, Homo sapiens
KVENHTACHCST

SEQ ID NO: 81 - protein, 12 aa, Homo sapiens
VENHTACHCSTC

SEQ ID NO: 82 - protein, 12 aa, Homo sapiens
ENHTACHCSTCY

SEQ ID NO: 83 - protein, 12 aa, Homo sapiens
NHTACHCSTCYY

SEQ ID NO: 84 - protein, 12 aa, Homo sapiens
HTACHCSTCYYH

SEQ ID NO: 85 - protein, 12 aa, Homo sapiens
TACHCSTCYYHK

SEQ ID NO: 86 - protein, 12 aa, Homo sapiens
ACHCSTCYYHKS

SEQ ID NO: 87 - protein, 12 aa, Homo sapiens
NSCELTNITIAI

SEQ ID NO: 88 - protein, 12 aa, Homo sapiens
SCELTNITIAIE

SEQ ID NO: 89 - protein, 12 aa, Homo sapiens
CELTNITIAIEK

SEQ ID NO: 90 - protein, 12 aa, Homo sapiens
ELTNITIAIEKE

SEQ ID NO: 91 - protein, 12 aa, Homo sapiens
LTNITIAIEKEE

SEQ ID NO: 92 - protein, 12 aa, Homo sapiens
TNITIAIEKEEC

SEQ ID NO: 93 - protein, 12 aa, Homo sapiens
NITIAIEKEECR

SEQ ID NO: 94 - protein, 12 aa, Homo sapiens
ITIAIEKEECRF

SEQ ID NO: 95 - protein, 12 aa, Homo sapiens
TIAIEKEECRFC

SEQ ID NO: 96 - protein, 12 aa, Homo sapiens
IAIEKEECRFCI

SEQ ID NO: 97 - protein, 12 aa, Homo sapiens
AIEKEECRFCIS

SEQ ID NO: 98 - protein, 12 aa, Homo sapiens
AIEKEECRFCIS

SEQ ID NO: 99 - protein, 12 aa, Homo sapiens
EKEECRFCISIN

SEQ ID NO: 100 - protein, 12 aa, Homo sapiens
KEECRFCISINT

SEQ ID NO: 101 - protein, 12 aa, Homo sapiens
EECRFCISINTT

SEQ ID NO: 102 - protein, 12 aa, Homo sapiens
ECRFCISINTTW

SEQ ID NO: 103 - protein, 12 aa, Homo sapiens
CRFCISINTTWC

SEQ ID NO: 104 - protein, 12 aa, Homo sapiens
RFCISINTTWCA

SEQ ID NO: 105 - protein, 12 aa, Homo sapiens
FCISINTTWCAG

SEQ ID NO: 106 - protein, 12 aa, Homo sapiens
CISINTTWCAGY

SEQ ID NO: 107 - protein, 12 aa, Homo sapiens
ISINTTWCAGYC

SEQ ID NO: 108 - protein, 12 aa, Homo sapiens
SINTTWCAGYCY

SEQ ID NO: 109 - protein, 12 aa, Homo sapiens
INTTWCAGYCYT

SEQ ID NO: 110 - protein, 12 aa, Homo sapiens
NTTWCAGYCYTR

SEQ ID NO: 111 - protein, 12 aa, Homo sapiens
TTWCAGYCYTRD

SEQ ID NO: 112 - protein, 12 aa, Homo sapiens
TWCAGYCYTRDL

SEQ ID NO: 113 - protein, 12 aa, Homo sapiens
WCAGYCYTRDLV

SEQ ID NO: 114 - protein, 12 aa, Homo sapiens
CAGYCYTRDLVY

SEQ ID NO: 115 - protein, 12 aa, Homo sapiens
AGYCYTRDLVYK

SEQ ID NO: 116 - protein, 12 aa, Homo sapiens
GYCYTRDLVYKD

SEQ ID NO: 117 - protein, 12 aa, Homo sapiens
YCYTRDLVYKDP

SEQ ID NO: 118 - protein, 12 aa, Homo sapiens
CYTRDLVYKDPA

SEQ ID NO: 119 - protein, 12 aa, Homo sapiens
YTRDLVYKDPAR

SEQ ID NO: 120 - protein, 12 aa, Homo sapiens
TRDLVYKDPARP

SEQ ID NO: 121 - protein, 12 aa, Homo sapiens
RDLVYKDPARPK

SEQ ID NO: 122 - protein, 12 aa, Homo sapiens
DLVYKDPARPKI

SEQ ID NO: 123 - protein, 12 aa, Homo sapiens
LVYKDPARPKIQ

SEQ ID NO: 124 - protein, 12 aa, Homo sapiens
VYKDPARPKIQK

SEQ ID NO: 125 - protein, 12 aa, Homo sapiens
YKDPARPKIQKT

SEQ ID NO: 126 - protein, 12 aa, Homo sapiens
KDPARPKIQKTC

SEQ ID NO: 127 - protein, 12 aa, Homo sapiens
DPARPKIQKTCT

SEQ ID NO: 128 - protein, 12 aa, Homo sapiens
PARPKIQKTCTF

SEQ ID NO: 129 - protein, 12 aa, Homo sapiens
ARPKIQKTCTFK

SEQ ID NO: 130 - protein, 12 aa, Homo sapiens
RPKIQKTCTFKE

SEQ ID NO: 131 - protein, 12 aa, Homo sapiens
PKIQKTCTFKEL

SEQ ID NO: 132 - protein, 12 aa, Homo sapiens
KIQKTCTFKELV

SEQ ID NO: 133 - protein, 12 aa, Homo sapiens
IQKTCTFKELVY

SEQ ID NO: 134 - protein, 12 aa, Homo sapiens
QKTCTFKELVYE

SEQ ID NO: 135 - protein, 12 aa, Homo sapiens
KTCTFKELVYET

SEQ ID NO: 136 - protein, 12 aa, Homo sapiens
TCTFKELVYETV

SEQ ID NO: 137 - protein, 12 aa, Homo sapiens
CTFKELVYETVR

SEQ ID NO: 138 - protein, 12 aa, Homo sapiens
TFKELVYETVRV

SEQ ID NO: 139 - protein, 12 aa, Homo sapiens
FKELVYETVRVP

SEQ ID NO: 140 - protein, 12 aa, Homo sapiens
KELVYETVRVPG

SEQ ID NO: 141 - protein, 12 aa, Homo sapiens
ELVYETVRVPGC

SEQ ID NO: 142 - protein, 12 aa, Homo sapiens
LVYETVRVPGCA

SEQ ID NO: 143 - protein, 12 aa, Homo sapiens
VYETVRVPGCAH

SEQ ID NO: 144 - protein, 12 aa, Homo sapiens
YETVRVPGCAHH

SEQ ID NO: 145 - protein, 12 aa, Homo sapiens
ETVRVPGCAHHA

SEQ ID NO: 146 - protein, 12 aa, Homo sapiens
TVRVPGCAHHAD

SEQ ID NO: 147 - protein, 12 aa, Homo sapiens
VRVPGCAHHADS

SEQ ID NO: 148 - protein, 12 aa, Homo sapiens
RVPGCAHHADSL

SEQ ID NO: 149 - protein, 12 aa, Homo sapiens
VPGCAHHADSLY

SEQ ID NO: 150 - protein, 12 aa, Homo sapiens
PGCAHHADSLYT

SEQ ID NO: 151 - protein, 12 aa, Homo sapiens
GCAHHADSLYTY

SEQ ID NO: 152 - protein, 12 aa, Homo sapiens
CAHHADSLYTYP

SEQ ID NO: 153 - protein, 12 aa, Homo sapiens
AHHADSLYTYPV

SEQ ID NO: 154 - protein, 12 aa, Homo sapiens
HHADSLYTYPVA

SEQ ID NO: 155 - protein, 12 aa, Homo sapiens
HADSLYTYPVAT

SEQ ID NO: 156 - protein, 12 aa, Homo sapiens
ADSLYTYPVATQ

SEQ ID NO: 157 - protein, 12 aa, Homo sapiens
DSLYTYPVATQC

SEQ ID NO: 158 - protein, 12 aa, Homo sapiens
SLYTYPVATQCH

SEQ ID NO: 159 - protein, 12 aa, Homo sapiens
LYTYPVATQCHC

SEQ ID NO: 160 - protein, 12 aa, Homo sapiens
YTYPVATQCHCG

SEQ ID NO: 161 - protein, 12 aa, Homo sapiens
TYPVATQCHCGK

SEQ ID NO: 162 - protein, 12 aa, Homo sapiens
YPVATQCHCGKC

SEQ ID NO: 163 - protein, 12 aa, Homo sapiens
PVATQCHCGKCD

SEQ ID NO: 164 - protein, 12 aa, Homo sapiens
VATQCHCGKCDS

SEQ ID NO: 165 - protein, 12 aa, Homo sapiens
ATQCHCGKCDSD

SEQ ID NO: 166 - protein, 12 aa, Homo sapiens
TQCHCGKCDSDS

SEQ ID NO: 167 - protein, 12 aa, Homo sapiens
QCHCGKCDSDST

SEQ ID NO: 168 - protein, 12 aa, Homo sapiens
CHCGKCDSDSTD

SEQ ID NO: 169 - protein, 12 aa, Homo sapiens
HCGKCDSDSTDC

SEQ ID NO: 170 - protein, 12 aa, Homo sapiens
CGKCDSDSTDCT

SEQ ID NO: 171 - protein, 12 aa, Homo sapiens
GKCDSDSTDCTV

SEQ ID NO: 172 - protein, 12 aa, Homo sapiens
KCDSDSTDCTVR

SEQ ID NO: 173 - protein, 12 aa, Homo sapiens
CDSDSTDCTVRG

SEQ ID NO: 174 - protein, 12 aa, Homo sapiens
DSDSTDCTVRGL

SEQ ID NO: 175 - protein, 12 aa, Homo sapiens
SDSTDCTVRGLG

SEQ ID NO: 176 - protein, 12 aa, Homo sapiens
DSTDCTVRGLGP

SEQ ID NO: 177 - protein, 12 aa, Homo sapiens
STDCTVRGLGPS

SEQ ID NO: 178 - protein, 12 aa, Homo sapiens
TDCTVRGLGPSY

SEQ ID NO: 179 - protein, 12 aa, Homo sapiens
DCTVRGLGPSYC

SEQ ID NO: 180 - protein, 12 aa, Homo sapiens
CTVRGLGPSYCS

SEQ ID NO: 181 - protein, 12 aa, Homo sapiens
TVRGLGPSYCSF

SEQ ID NO: 182 - protein, 12 aa, Homo sapiens
VRGLGPSYCSFG

SEQ ID NO: 183 - protein, 12 aa, Homo sapiens
RGLGPSYCSFGE

SEQ ID NO: 184 - protein, 12 aa, Homo sapiens
GLGPSYCSFGEM

SEQ ID NO: 185 - protein, 12 aa, Homo sapiens
LGPSYCSFGEMK

SEQ ID NO: 186 - protein, 12 aa, Homo sapiens
GPSYCSFGEMKE

SEQ ID NO: 187 - protein, 12 aa, Artificial
  Fragment of hFSH with Cys attached to the C or N terminal
APDVQDCPECTC

SEQ ID NO: 188 - protein, 12 aa, Artificial
  Fragment of hFSH with Cys attached to the C or N terminal
CPDVQDCPECTL

SEQ ID NO: 189 - protein, 12 aa, Artificial
  Fragment of hFSH with Cys attached to the C or N terminal
DVQDCPECTLQC

SEQ ID NO: 190 - protein, 12 aa, Artificial
  Fragment of hFSH with Cys attached to the C or N terminal
CVQDCPECTLQE

SEQ ID NO: 191 - protein, 12 aa, Artificial
  Fragment of hFSH with Cys attached to the C or N terminal
QDCPECTLQENC

SEQ ID NO: 192 - protein, 12 aa, Artificial
  Fragment of hFSH with Cys attached to the C or N terminal
CDCPECTLQENP

SEQ ID NO: 193 - protein, 12 aa, Artificial
  Fragment of hFSH with Cys attached to the C or N terminal
CPECTLQENPFC

SEQ ID NO: 194 - protein, 12 aa, Artificial
  Fragment of hFSH with Cys attached to the C or N terminal
ECTLQENPFFSC

SEQ ID NO: 195 - protein, 12 aa, Artificial
  Fragment of hFSH with Cys attached to the C or N terminal
CCTLQENPFFSQ

SEQ ID NO: 196 - protein, 12 aa, Artificial
  Fragment of hFSH with Cys attached to the C or N terminal
TLQENPFFSQPC

SEQ ID NO: 197 - protein, 12 aa, Artificial
  Fragment of hFSH with Cys attached to the C or N terminal
CLQENPFFSQPG

SEQ ID NO: 198 - protein, 12 aa, Artificial
  Fragment of hFSH with Cys attached to the C or N terminal
QENPFFSQPGAC

SEQ ID NO: 199 - protein, 12 aa, Artificial
  Fragment of hFSH with Cys attached to the C or N terminal
CENPFFSQPGAP

SEQ ID NO: 200 - protein, 12 aa, Artificial
  Fragment of hFSH with Cys attached to the C or N terminal
NPFFSQPGAPIC

SEQ ID NO: 201 - protein, 12 aa, Artificial
  Fragment of hFSH with Cys attached to the C or N terminal
CPFFSQPGAPIL

SEQ ID NO: 202 - protein, 12 aa, Artificial
  Fragment of hFSH with Cys attached to the C or N terminal
CFSQPGAPILQC

SEQ ID NO: 203 - protein, 12 aa, Artificial
  Fragment of hFSH with Cys attached to the C or N terminal
SQPGAPILQCMC

SEQ ID NO: 204 - protein, 12 aa, Artificial
  Fragment of hFSH with Cys attached to the C or N terminal
CQPGAPILQCMG

SEQ ID NO: 205 - protein, 12 aa, Artificial
  Fragment of hFSH with Cys attached to the C or N terminal
CGAPILQCMGCC

SEQ ID NO: 206 - protein, 12 aa, Artificial
  Fragment of hFSH with Cys attached to the C or N terminal
APILQCMGCCFC

SEQ ID NO: 207 - protein, 12 aa, Artificial
  Fragment of hFSH with Cys attached to the C or N terminal
CPILQCMGCCFS

SEQ ID NO: 208 - protein, 12 aa, Artificial
  Fragment of hFSH with Cys attached to the C or N terminal
ILQCMGCCFSRC

SEQ ID NO: 209 - protein, 12 aa, Artificial
  Fragment of hFSH with Cys attached to the C or N terminal
CLQCMGCCFSRA

SEQ ID NO: 210 - protein, 12 aa, Artificial
  Fragment of hFSH with Cys attached to the C or N terminal
QCMGCCFSRAYC

SEQ ID NO: 211 - protein, 12 aa, Artificial
  Fragment of hFSH with Cys attached to the C or N terminal
CCMGCCFSRAYP

SEQ ID NO: 212 - protein, 12 aa, Artificial
  Fragment of hFSH with Cys attached to the C or N terminal
MGCCFSRAYPTC

SEQ ID NO: 213 - protein, 12 aa, Artificial
  Fragment of hFSH with Cys attached to the C or N terminal
CGCCFSRAYPTP

SEQ ID NO: 214 - protein, 12 aa, Artificial
  Fragment of hFSH with Cys attached to the C or N terminal
CCFSRAYPTPLC

SEQ ID NO: 215 - protein, 12 aa, Artificial
  Fragment of hFSH with Cys attached to the C or N terminal
FSRAYPTPLRSC

SEQ ID NO: 216 - protein, 12 aa, Artificial
  Fragment of hFSH with Cys attached to the C or N terminal
CSRAYPTPLRSK

SEQ ID NO: 217 - protein, 12 aa, Artificial
  Fragment of hFSH with Cys attached to the C or N terminal
RAYPTPLRSKKC

SEQ ID NO: 218 - protein, 12 aa, Artificial
  Fragment of hFSH with Cys attached to the C or N terminal
CAYPTPLRSKKT

SEQ ID NO: 219 - protein, 12 aa, Artificial
  Fragment of hFSH with Cys attached to the C or N terminal
YPTPLRSKKTMC

SEQ ID NO: 220 - protein, 12 aa, Artificial
  Fragment of hFSH with Cys attached to the C or N terminal
CPTPLRSKKTML

SEQ ID NO: 221 - protein, 12 aa, Artificial
  Fragment of hFSH with Cys attached to the C or N terminal
TPLRSKKTMLVC

SEQ ID NO: 222 - protein, 12 aa, Artificial
  Fragment of hFSH with Cys attached to the C or N terminal
CPLRSKKTMLVQ

SEQ ID NO: 223 - protein, 12 aa, Artificial
  Fragment of hFSH with Cys attached to the C or N terminal
LRSKKTMLVQKC

SEQ ID NO: 224 - protein, 12 aa, Artificial
  Fragment of hFSH with Cys attached to the C or N terminal
CRSKKTMLVQKN

SEQ ID NO: 225 - protein, 12 aa, Artificial
  Fragment of hFSH with Cys attached to the C or N terminal
SKKTMLVQKNVC

SEQ ID NO: 226 - protein, 12 aa, Artificial
  Fragment of hFSH with Cys attached to the C or N terminal
CKKTMLVQKNVT

SEQ ID NO: 227 - protein, 12 aa, Artificial
  Fragment of hFSH with Cys attached to the C or N terminal
KTMLVQKNVTSC

SEQ ID NO: 228 - protein, 12 aa, Artificial
  Fragment of hFSH with Cys attached to the C or N terminal
CTMLVQKNVTSE

SEQ ID NO: 229 - protein, 12 aa, Artificial
  Fragment of hFSH with Cys attached to the C or N terminal
MLVQKNVTSESC

SEQ ID NO: 230 - protein, 12 aa, Artificial
  Fragment of hFSH with Cys attached to the C or N terminal
CLVQKNVTSEST

SEQ ID NO: 231 - protein, 12 aa, Artificial
  Fragment of hFSH with Cys attached to the C or N terminal
CQKNVTSESTCC

SEQ ID NO: 232 - protein, 12 aa, Artificial
  Fragment of hFSH with Cys attached to the C or N terminal
KNVTSESTCCVC

SEQ ID NO: 233 - protein, 12 aa, Artificial
  Fragment of hFSH with Cys attached to the C or N terminal
CNVTSESTCCVA

SEQ ID NO: 234 - protein, 12 aa, Artificial
  Fragment of hFSH with Cys attached to the C or N terminal
VTSESTCCVAKC

SEQ ID NO: 235 - protein, 12 aa, Artificial
  Fragment of hFSH with Cys attached to the C or N terminal
CTSESTCCVAKS

SEQ ID NO: 236 - protein, 12 aa, Artificial
  Fragment of hFSH with Cys attached to the C or N terminal
SESTCCVAKSYC

SEQ ID NO: 237 - protein, 12 aa, Artificial
  Fragment of hFSH with Cys attached to the C or N terminal
CESTCCVAKSYN

SEQ ID NO: 238 - protein, 12 aa, Artificial
  Fragment of hFSH with Cys attached to the C or N terminal
STCCVAKSYNRC

SEQ ID NO: 239 - protein, 12 aa, Artificial
  Fragment of hFSH with Cys attached to the C or N terminal
CTCCVAKSYNRV

SEQ ID NO: 240 - protein, 12 aa, Artificial
  Fragment of hFSH with Cys attached to the C or N terminal
CCVAKSYNRVTC

SEQ ID NO: 241 - protein, 12 aa, Artificial
  Fragment of hFSH with Cys attached to the C or N terminal
VAKSYNRVTVMC

SEQ ID NO: 242 - protein, 12 aa, Artificial
  Fragment of hFSH with Cys attached to the C or N terminal
CAKSYNRVTVMG

SEQ ID NO: 243 - protein, 12 aa, Artificial
  Fragment of hFSH with Cys attached to the C or N terminal
KSYNRVTVMGGC

SEQ ID NO: 244 - protein, 12 aa, Artificial
  Fragment of hFSH with Cys attached to the C or N terminal
CSYNRVTVMGGF

SEQ ID NO: 245 - protein, 12 aa, Artificial
  Fragment of hFSH with Cys attached to the C or N terminal
YNRVTVMGGFKC

SEQ ID NO: 246 - protein, 12 aa, Artificial
  Fragment of hFSH with Cys attached to the C or N terminal
CNRVTVMGGFKV

SEQ ID NO: 247 - protein, 12 aa, Artificial
  Fragment of hFSH with Cys attached to the C or N terminal
RVTVMGGFKVEC

SEQ ID NO: 248 - protein, 12 aa, Artificial
  Fragment of hFSH with Cys attached to the C or N terminal
CVTVMGGFKVEN

SEQ ID NO: 249 - protein, 12 aa, Artificial
  Fragment of hFSH with Cys attached to the C or N terminal
TVMGGFKVENHC

SEQ ID NO: 250 - protein, 12 aa, Artificial
  Fragment of hFSH with Cys attached to the C or N terminal
CVMGGFKVENHT

SEQ ID NO: 251 - protein, 12 aa, Artificial
  Fragment of hFSH with Cys attached to the C or N terminal
CGGFKVENHTAC

SEQ ID NO: 252 - protein, 12 aa, Artificial
  Fragment of hFSH with Cys attached to the C or N terminal
CFKVENHTACHC

SEQ ID NO: 253 - protein, 12 aa, Artificial
  Fragment of hFSH with Cys attached to the C or N terminal
KVENHTACHCSC

SEQ ID NO: 254 - protein, 12 aa, Artificial
  Fragment of hFSH with Cys attached to the C or N terminal
CVENHTACHCST

SEQ ID NO: 255 - protein, 12 aa, Artificial
  Fragment of hFSH with Cys attached to the C or N terminal
ENHTACHCSTCC

SEQ ID NO: 256 - protein, 12 aa, Artificial
  Fragment of hFSH with Cys attached to the C or N terminal
CNHTACHCSTCY

SEQ ID NO: 257 - protein, 12 aa, Artificial
  Fragment of hFSH with Cys attached to the C or N terminal
HTACHCSTCYYC

SEQ ID NO: 258 - protein, 12 aa, Artificial
  Fragment of hFSH with Cys attached to the C or N terminal
CTACHCSTCYYH

SEQ ID NO: 259 - protein, 12 aa, Artificial
  Fragment of hFSH with Cys attached to the C or N terminal
ACHCSTCYYHKC

SEQ ID NO: 260 - protein, 12 aa, Artificial
  Fragment of hFSH with Cys attached to the C or N terminal
CCHCSTCYYHKS

SEQ ID NO: 261 - protein, 12 aa, Artificial
  Fragment of hFSH with Cys attached to the C or N terminal
NSCELTNITIAC

SEQ ID NO: 262 - protein, 12 aa, Artificial
  Fragment of hFSH with Cys attached to the C or N terminal
CSCELTNITIAI

SEQ ID NO: 263 - protein, 12 aa, Artificial
  Fragment of hFSH with Cys attached to the C or N terminal
CELTNITIAIEC

SEQ ID NO: 264 - protein, 12 aa, Artificial
  Fragment of hFSH with Cys attached to the C or N terminal
LTNITIAIEKEC

SEQ ID NO: 265 - protein, 12 aa, Artificial
  Fragment of hFSH with Cys attached to the C or N terminal
CTNITIAIEKEE

SEQ ID NO: 266 - protein, 12 aa, Artificial
  Fragment of hFSH with Cys attached to the C or N terminal
NITIAIEKEECC

SEQ ID NO: 267 - protein, 12 aa, Artificial
  Fragment of hFSH with Cys attached to the C or N terminal
CITIAIEKEECR

SEQ ID NO: 268 - protein, 12 aa, Artificial
  Fragment of hFSH with Cys attached to the C or N terminal
CIAIEKEECRFC

SEQ ID NO: 269 - protein, 12 aa, Artificial
  Fragment of hFSH with Cys attached to the C or N terminal
AIEKEECRFCIC

SEQ ID NO: 270 - protein, 12 aa, Artificial
  Fragment of hFSH with Cys attached to the C or N terminal
CIEKEECRFCIS

SEQ ID NO: 271 - protein, 12 aa, Artificial
  Fragment of hFSH with Cys attached to the C or N terminal
EKEECRFCISIC

SEQ ID NO: 272 - protein, 12 aa, Artificial
  Fragment of hFSH with Cys attached to the C or N terminal
CKEECRFCISIN

SEQ ID NO: 273 - protein, 12 aa, Artificial
  Fragment of hFSH with Cys attached to the C or N terminal
EECRFCISINTC

SEQ ID NO: 274 - protein, 12 aa, Artificial
  Fragment of hFSH with Cys attached to the C or N terminal
CECRFCISINTT

SEQ ID NO: 275 - protein, 12 aa, Artificial
  Fragment of hFSH with Cys attached to the C or N terminal
FCISINTTWCAC

SEQ ID NO: 276 - protein, 12 aa, Artificial
  Fragment of hFSH with Cys attached to the C or N terminal
CCISINTTWCAG

SEQ ID NO: 277 - protein, 12 aa, Artificial
  Fragment of hFSH with Cys attached to the C or N terminal
CSINTTWCAGYC

SEQ ID NO: 278 - protein, 12 aa, Artificial
  Fragment of hFSH with Cys attached to the C or N terminal
INTTWCAGYCYC

SEQ ID NO: 279 - protein, 12 aa, Artificial
  Fragment of hFSH with Cys attached to the C or N terminal
CNTTWCAGYCYT

SEQ ID NO: 280 - protein, 12 aa, Artificial
  Fragment of hFSH with Cys attached to the C or N terminal
TTWCAGYCYTRC

SEQ ID NO: 281 - protein, 12 aa, Artificial
  Fragment of hFSH with Cys attached to the C or N terminal
CTWCAGYCYTRD

SEQ ID NO: 282 - protein, 12 aa, Artificial
  Fragment of hFSH with Cys attached to the C or N terminal
WCAGYCYTRDLC

SEQ ID NO: 283 - protein, 12 aa, Artificial
  Fragment of hFSH with Cys attached to the C or N terminal
CCAGYCYTRDLV

SEQ ID NO: 284 - protein, 12 aa, Artificial
  Fragment of hFSH with Cys attached to the C or N terminal
AGYCYTRDLVYC

SEQ ID NO: 285 - protein, 12 aa, Artificial
  Fragment of hFSH with Cys attached to the C or N terminal
CGYCYTRDLVYK

SEQ ID NO: 286 - protein, 12 aa, Artificial
  Fragment of hFSH with Cys attached to the C or N terminal
YCYTRDLVYKDC

SEQ ID NO: 287 - protein, 12 aa, Artificial
  Fragment of hFSH with Cys attached to the C or N terminal
CCYTRDLVYKDP

SEQ ID NO: 288 - protein, 12 aa, Artificial
  Fragment of hFSH with Cys attached to the C or N terminal
YTRDLVYKDPAC

SEQ ID NO: 289 - protein, 12 aa, Artificial
  Fragment of hFSH with Cys attached to the C or N terminal
CTRDLVYKDPAR

SEQ ID NO: 290 - protein, 12 aa, Artificial
  Fragment of hFSH with Cys attached to the C or N terminal
RDLVYKDPARPC

SEQ ID NO: 291 - protein, 12 aa, Artificial
  Fragment of hFSH with Cys attached to the C or N terminal
CDLVYKDPARPK

SEQ ID NO: 292 - protein, 12 aa, Artificial
  Fragment of hFSH with Cys attached to the C or N terminal
LVYKDPARPKIC

SEQ ID NO: 293 - protein, 12 aa, Artificial
  Fragment of hFSH with Cys attached to the C or N terminal
CVYKDPARPKIQ

SEQ ID NO: 294 - protein, 12 aa, Artificial
  Fragment of hFSH with Cys attached to the C or N terminal
YKDPARPKIQKC

SEQ ID NO: 295 - protein, 12 aa, Artificial
  Fragment of hFSH with Cys attached to the C or N terminal
CKDPARPKIQKT

SEQ ID NO: 296 - protein, 12 aa, Artificial
  Fragment of hFSH with Cys attached to the C or N terminal
DPARPKIQKTCC

SEQ ID NO: 297 - protein, 12 aa, Artificial
  Fragment of hFSH with Cys attached to the C or N terminal
CPARPKIQKTCT

SEQ ID NO: 298 - protein, 12 aa, Artificial
  Fragment of hFSH with Cys attached to the C or N terminal
ARPKIQKTCTFC

SEQ ID NO: 299 - protein, 12 aa, Artificial
  Fragment of hFSH with Cys attached to the C or N terminal
CRPKIQKTCTFK

SEQ ID NO: 300 - protein, 12 aa, Artificial
  Fragment of hFSH with Cys attached to the C or N terminal
PKIQKTCTFKEC

SEQ ID NO: 301 - protein, 12 aa, Artificial
  Fragment of hFSH with Cys attached to the C or N terminal
CKIQKTCTFKEL

SEQ ID NO: 302 - protein, 12 aa, Artificial
  Fragment of hFSH with Cys attached to the C or N terminal
IQKTCTFKELVC

SEQ ID NO: 303 - protein, 12 aa, Artificial
  Fragment of hFSH with Cys attached to the C or N terminal
CQKTCTFKELVY

SEQ ID NO: 304 - protein, 12 aa, Artificial
  Fragment of hFSH with Cys attached to the C or N terminal
KTCTFKELVYEC

SEQ ID NO: 305 - protein, 12 aa, Artificial
  Fragment of hFSH with Cys attached to the C or N terminal
CTCTFKELVYET

SEQ ID NO: 306 - protein, 12 aa, Artificial
  Fragment of hFSH with Cys attached to the C or N terminal
CTFKELVYETVC

SEQ ID NO: 307 - protein, 12 aa, Artificial
  Fragment of hFSH with Cys attached to the C or N terminal
FKELVYETVRVC

SEQ ID NO: 308 - protein, 12 aa, Artificial
  Fragment of hFSH with Cys attached to the C or N terminal
CKELVYETVRVP

SEQ ID NO: 309 - protein, 12 aa, Artificial
  Fragment of hFSH with Cys attached to the C or N terminal
CLVYETVRVPGC

SEQ ID NO: 310 - protein, 12 aa, Artificial
  Fragment of hFSH with Cys attached to the C or N terminal
VYETVRVPGCAC

SEQ ID NO: 311 - protein, 12 aa, Artificial
  Fragment of hFSH with Cys attached to the C or N terminal
CYETVRVPGCAH

SEQ ID NO: 312 - protein, 12 aa, Artificial
  Fragment of hFSH with Cys attached to the C or N terminal
ETVRVPGCAHHC

SEQ ID NO: 313 - protein, 12 aa, Artificial
  Fragment of hFSH with Cys attached to the C or N terminal
CTVRVPGCAHHA

SEQ ID NO: 314 - protein, 12 aa, Artificial
  Fragment of hFSH with Cys attached to the C or N terminal
VRVPGCAHHADC

SEQ ID NO: 315 - protein, 12 aa, Artificial
  Fragment of hFSH with Cys attached to the C or N terminal
CRVPGCAHHADS

SEQ ID NO: 316 - protein, 12 aa, Artificial
  Fragment of hFSH with Cys attached to the C or N terminal
VPGCAHHADSLC

SEQ ID NO: 317 - protein, 12 aa, Artificial
  Fragment of hFSH with Cys attached to the C or N terminal
CPGCAHHADSLY

SEQ ID NO: 318 - protein, 12 aa, Artificial
  Fragment of hFSH with Cys attached to the C or N terminal
GCAHHADSLYTC

SEQ ID NO: 319 - protein, 12 aa, Artificial
  Fragment of hFSH with Cys attached to the C or N terminal
CCAHHADSLYTY

SEQ ID NO: 320 - protein, 12 aa, Artificial
  Fragment of hFSH with Cys attached to the C or N terminal
AHHADSLYTYPC

SEQ ID NO: 321 - protein, 12 aa, Artificial
  Fragment of hFSH with Cys attached to the C or N terminal
CHHADSLYTYPV

SEQ ID NO: 322 - protein, 12 aa, Artificial
  Fragment of hFSH with Cys attached to the C or N terminal
HADSLYTYPVAC

SEQ ID NO: 323 - protein, 12 aa, Artificial
  Fragment of hFSH with Cys attached to the C or N terminal
CADSLYTYPVAT

SEQ ID NO: 324 - protein, 12 aa, Artificial
  Fragment of hFSH with Cys attached to the C or N terminal
CSLYTYPVATQC

SEQ ID NO: 325 - protein, 12 aa, Artificial
  Fragment of hFSH with Cys attached to the C or N terminal
CYTYPVATQCHC

SEQ ID NO: 326 - protein, 12 aa, Artificial
  Fragment of hFSH with Cys attached to the C or N terminal
TYPVATQCHCGC

SEQ ID NO: 327 - protein, 12 aa, Artificial
  Fragment of hFSH with Cys attached to the C or N terminal
CYPVATQCHCGK

SEQ ID NO: 328 - protein, 12 aa, Artificial
  Fragment of hFSH with Cys attached to the C or N terminal
PVATQCHCGKCC

SEQ ID NO: 329 - protein, 12 aa, Artificial
  Fragment of hFSH with Cys attached to the C or N terminal
CVATQCHCGKCD

SEQ ID NO: 330 - protein, 12 aa, Artificial
  Fragment of hFSH with Cys attached to the C or N terminal
ATQCHCGKCDSC

SEQ ID NO: 331 - protein, 12 aa, Artificial
  Fragment of hFSH with Cys attached to the C or N terminal
CTQCHCGKCDSD

SEQ ID NO: 332 - protein, 12 aa, Artificial
  Fragment of hFSH with Cys attached to the C or N terminal
QCHCGKCDSDSC

SEQ ID NO: 333 - protein, 12 aa, Artificial
  Fragment of hFSH with Cys attached to the C or N terminal
CCHCGKCDSDST

SEQ ID NO: 334 - protein, 12 aa, Artificial
  Fragment of hFSH with Cys attached to the C or N terminal
CCGKCDSDSTDC

SEQ ID NO: 335 - protein, 12 aa, Artificial
  Fragment of hFSH with Cys attached to the C or N terminal
GKCDSDSTDCTC

SEQ ID NO: 336 - protein, 12 aa, Artificial
  Fragment of hFSH with Cys attached to the C or N terminal
CKCDSDSTDCTV

SEQ ID NO: 337 - protein, 12 aa, Artificial
  Fragment of hFSH with Cys attached to the C or N terminal
CDSDSTDCTVRC

SEQ ID NO: 338 - protein, 12 aa, Artificial
  Fragment of hFSH with Cys attached to the C or N terminal
SDSTDCTVRGLC

SEQ ID NO: 339 - protein, 12 aa, Artificial
  Fragment of hFSH with Cys attached to the C or N terminal
CDSTDCTVRGLG

SEQ ID NO: 340 - protein, 12 aa, Artificial
  Fragment of hFSH with Cys attached to the C or N terminal
STDCTVRGLGPC

SEQ ID NO: 341 - protein, 12 aa, Artificial
  Fragment of hFSH with Cys attached to the C or N terminal
CTDCTVRGLGPS

SEQ ID NO: 342 - protein, 12 aa, Artificial
  Fragment of hFSH with Cys attached to the C or N terminal
CCTVRGLGPSYC

SEQ ID NO: 343 - protein, 12 aa, Artificial
  Fragment of hFSH with Cys attached to the C or N terminal
TVRGLGPSYCSC

SEQ ID NO: 344 - protein, 12 aa, Artificial
  Fragment of hFSH with Cys attached to the C or N terminal
CVRGLGPSYCSF

SEQ ID NO: 345 - protein, 12 aa, Artificial
  Fragment of hFSH with Cys attached to the C or N terminal
RGLGPSYCSFGC

SEQ ID NO: 346 - protein, 12 aa, Artificial
  Fragment of hFSH with Cys attached to the C or N terminal
CGLGPSYCSFGE

SEQ ID NO: 347 - protein, 12 aa, Artificial
  Fragment of hFSH with Cys attached to the C or N terminal
LGPSYCSFGEMC

SEQ ID NO: 348 - protein, 12 aa, Artificial
  Fragment of hFSH with Cys attached to the C or N terminal
CGPSYCSFGEMK

SEQ ID NO: 349 - protein, 12 aa, Artificial
  Fragment of hFSH with Cys attached to the C or N terminal
PSYCSFGEMKEC

SEQ ID NO: 350 - protein, 25 aa, Artificial
  Concatonated sequences of hFSH
  MISC_FEATURE (13)..(13): Xaa represents a bromoacetamide group
VYETVRVPGCACXADSLYTYPVATQ

SEQ ID NO: 351 - protein, 13 aa, Artificial
  Fragment of hFSH with Cys attached to the C or N terminal
KTATFKELVYETC

SEQ ID NO: 352 - protein, 13 aa, Artificial
  Fragment of hFSH with Cys attached to the C or N terminal
CTATFKELVYETV

SEQ ID NO: 353 - protein, 13 aa, Artificial
  Fragment of hFSH with Cys attached to the C or N terminal
ATFKELVYETVRC

SEQ ID NO: 354 - protein, 13 aa, Artificial
  Fragment of hFSH with Cys attached to the C or N terminal
CTFKELVYETVRV

SEQ ID NO: 355 - protein, 13 aa, Artificial
  Fragment of hFSH with Cys attached to the C or N terminal
FKELVYETVRVPC

SEQ ID NO: 356 - protein, 13 aa, Artificial
  Fragment of hFSH with Cys attached to the C or N terminal
CKELVYETVRVPG

SEQ ID NO: 357 - protein, 13 aa, Artificial
  Fragment of hFSH with Cys attached to the C or N terminal
ELVYETVRVPGAC

SEQ ID NO: 358 - protein, 13 aa, Artificial
  Fragment of hFSH with Cys attached to the C or N terminal
CLVYETVRVPGAA

SEQ ID NO: 359 - protein, 13 aa, Artificial
  Fragment of hFSH with Cys attached to the C or N terminal
VYETVRVPGAAHC

SEQ ID NO: 360 - protein, 13 aa, Artificial
  Fragment of hFSH with Cys attached to the C or N terminal
CYETVRVPGAAHH

SEQ ID NO: 361 - protein, 13 aa, Artificial
  Fragment of hFSH with Cys attached to the C or N terminal
ETVRVPGAAHHAC

SEQ ID NO: 362 - protein, 13 aa, Artificial
  Fragment of hFSH with Cys attached to the C or N terminal
CTVRVPGAAHHAD

SEQ ID NO: 363 - protein, 13 aa, Artificial
  Fragment of hFSH with Cys attached to the C or N terminal
VRVPGAAHHADSC

SEQ ID NO: 364 - protein, 13 aa, Artificial
  Fragment of hFSH with Cys attached to the C or N terminal
CRVPGAAHHADSL

SEQ ID NO: 365 - protein, 13 aa, Artificial
  Fragment of hFSH with Cys attached to the C or N terminal
VPGAAHHADSLYC

SEQ ID NO: 366 - protein, 13 aa, Artificial
  Fragment of hFSH with Cys attached to the C or N terminal
CPGAAHHADSLYT

SEQ ID NO: 367 - protein, 13 aa, Artificial
  Fragment of hFSH with Cys attached to the C or N terminal
GAAHHADSLYTYC

SEQ ID NO: 368 - protein, 13 aa, Artificial
  Fragment of hFSH with Cys attached to the C or N terminal
CAAHHADSLYTYP

SEQ ID NO: 369 - protein, 13 aa, Artificial
  Fragment of hFSH with Cys attached to the C or N terminal
AHHADSLYTYPVC

SEQ ID NO: 370 - protein, 13 aa, Artificial
  Fragment of hFSH with Cys attached to the C or N terminal
CHHADSLYTYPVA

SEQ ID NO: 371 - protein, 13 aa, Artificial
  Fragment of hFSH with Cys attached to the C or N terminal
HADSLYTYPVATC

SEQ ID NO: 372 - protein, 13 aa, Artificial
  Fragment of hFSH with Cys attached to the C or N terminal
CADSLYTYPVATQ

SEQ ID NO: 373 - protein, 13 aa, Artificial
  Fragment of hFSH with Cys attached to the C or N terminal
DSLYTYPVATQAC

SEQ ID NO: 374 - protein, 13 aa, Artificial
  Fragment of hFSH with Cys attached to the C or N terminal
CSLYTYPVATQAH

SEQ ID NO: 375 - protein, 13 aa, Artificial
  Fragment of hFSH with Cys attached to the C or N terminal
LYTYPVATQAHAC

SEQ ID NO: 376 - protein, 13 aa, Artificial
  Fragment of hFSH with Cys attached to the C or N terminal
CYTYPVATQAHAG

SEQ ID NO: 377 - protein, 13 aa, Artificial
  Fragment of hFSH with Cys attached to the C or N terminal
TYPVATQAHAGKC

SEQ ID NO: 378 - protein, 13 aa, Artificial
  Fragment of hFSH with Cys attached to the C or N terminal
CYPVATQAHAGKA

SEQ ID NO: 379 - protein, 13 aa, Artificial
  Fragment of hFSH with Cys attached to the C or N terminal
PVATQAHAGKADC

SEQ ID NO: 380 - protein, 13 aa, Artificial
  Fragment of hFSH with Cys attached to the C or N terminal
CVATQAHAGKADS

SEQ ID NO: 381 - protein, 13 aa, Artificial
  Fragment of hFSH with Cys attached to the C or N terminal
ATQAHAGKADSDC

SEQ ID NO: 382 - protein, 13 aa, Artificial
  Fragment of hFSH with Cys attached to the C or N terminal
CTQAHAGKADSDS

SEQ ID NO: 383 - protein, 13 aa, Artificial
  Fragment of hFSH with Cys attached to the C or N terminal
QAHAGKADSDSTC

SEQ ID NO: 384 - protein, 13 aa, Artificial
  Fragment of hFSH with Cys attached to the C or N terminal
CAHAGKADSDSTD

SEQ ID NO: 385 - protein, 13 aa, Artificial
  Fragment of hFSH with Cys attached to the C or N terminal
ADSLYTYPVATQC

SEQ ID NO: 386 - protein, 10 aa, Artificial
  Fragment of hFSH with Cys attached to the C or N terminal
VYETVRVPGC